(19) United States
(12) Patent Application Publication
(10) Pub. No.: US 2020/0036983 A1
(43) Pub. Date: Jan. 30, 2020

(54) PICTURE FILE PROCESING METHOD AND APPARATUS, AND STORAGE MEDIUM

(71) Applicant: Tencent Technology (Shenzhen) Company Limited, Shenzhen (CN)

(72) Inventors: Shitao WANG, Shenzhen (CN); Xiaoyu LIU, Shenzhen (CN); Jiajun CHEN, Shenzhen (CN); Xiaozheng HUANG, Shenzhen (CN); Piao DING, Shenzhen (CN); Haijun LIU, Shenzhen (CN); Binji LUO, Shenzhen (CN); Xinxing CHEN, Shenzhen (CN)

(21) Appl. No.: 16/595,008

(22) Filed: Oct. 7, 2019

Related U.S. Application Data
(63) Continuation of application No. PCT/CN2018/079113, filed on Mar. 15, 2018.

(30) Foreign Application Priority Data
Apr. 8, 2017 (CN) 201710225910.3

(51) Int. Cl. H04N 19/157; H04N 19/186; H04N 19/70; H04N 19/172

(52) U.S. Cl. CPC H04N 19/157; H04N 19/172; H04N 19/70; H04N 19/186

(57) ABSTRACT

Embodiments of this application disclose an image file processing method performed at a computing device. The method includes: obtaining RGBA data corresponding to a first image in an image file, and separating the RGBA data to obtain RGB data and transparency data of the first image; encoding the RGB data of the first image according to a first video encoding mode, to generate first stream data; encoding the transparency data of the first image according to a second video encoding mode, to generate second stream data; and combining the first stream data and the second stream data into a stream data segment of the image file.

### CROSS-REFERENCE TO RELATED APPLICATIONS

This application is a continuation application of PCT/CN2018/079113, entitled “IMAGE FILE PROCESSING METHOD AND APPARATUS, AND STORAGE MEDIUM” filed on Mar. 15, 2018, which claims priority to Chinese Patent Application No. 201710225910.3, entitled “IMAGE FILE PROCESSING METHOD” filed with the Chinese Patent Office on Apr. 8, 2017, all of which are incorporated by reference in their entirety.

### FIELD OF THE TECHNOLOGY

This application relates to the field of computer technologies, and in particular, to an image file processing method and apparatus, and a storage medium.

### BACKGROUND OF THE DISCLOSURE

With development of the mobile Internet, downloading traffic of a terminal device is greatly increased, and among downloading traffic of a user, image file traffic accounts for a very large proportion. A large quantity of image files also cause very large pressure on network transmission bandwidth load. If a size of an image file can be reduced, not only a loading speed can be improved, but also bandwidth and storage costs can be significantly reduced.

### SUMMARY

Embodiments of this application provide an image file processing method and apparatus, and a storage medium, to encode RGB data and transparency data respectively by using video encoding modes, thereby improving a compression ratio of an image file and ensuring quality of the image file.

According to a first aspect of this application, an embodiment of this application provides an image file processing method performed at a computing device having one or more processors and memory storing a plurality of programs to be executed by the one or more processors, the method comprising:

obtaining RGBA data corresponding to a first image in an image file;

separating the RGBA data to obtain RGB data and transparency data of the first image, the RGB data being color data comprised in the RGBA data, and the transparency data being transparency data comprised in the RGBA data;

encoding the RGB data of the first image, to generate first stream data;

encoding the transparency data of the first image, to generate second stream data; and

combining the first stream data and the second stream data into a stream data segment of the image file;

wherein at least image header information corresponding to the image file comprises image feature information indication of transparency data in the image file.

According to a second aspect of this application, an embodiment of this application provides a computing device having one or more processors, memory coupled to the one or more processors, and a plurality of programs stored in the memory. The plurality of programs, when executed by the one or more processors, cause the computing device to perform the aforementioned image file processing method.

According to a third aspect of this application, an embodiment of this application provides non-transitory computer readable storage medium storing a plurality of machine readable instructions in connection with a computing device having one or more processors. The plurality of machine readable instructions, when executed by the one or more processors, cause the computing device to perform the aforementioned image file processing method.

### BRIEF DESCRIPTION OF THE DRAWINGS

To describe the technical solutions in embodiments of this application more clearly, the following briefly describes the accompanying drawings required for describing the embodiments of this application. Apparently, the accompanying drawings in the following description show merely some embodiments of this application, and a person of ordinary skill in the art may derive other drawings from these accompanying drawings without creative efforts.

FIG. 1a is a schematic diagram of an implementation environment of an image file processing method according to an embodiment of this application.

FIG. 1b is a schematic diagram of an internal structure of a computing device for implementing an image file processing method according to an embodiment of this application.

FIG. 1c is a schematic flowchart of an image file processing method according to an embodiment of this application.

FIG. 2 is a schematic flowchart of another image file processing method according to an embodiment of this application.

FIG. 3 is an example diagram of a plurality of frames of images included in an image file in a dynamic format according to an embodiment of this application.

FIG. 4a is a schematic flowchart of another image file processing method according to an embodiment of this application.

FIG. 4b is an example diagram of converting RGB data into YUV data according to an embodiment of this application.

FIG. 4c is an example diagram of converting transparency data into YUV data according to an embodiment of this application.

FIG. 4d is an example diagram of converting transparency data into YUV data according to an embodiment of this application.

FIG. 5a is an example diagram of image header information according to an embodiment of this application.

FIG. 5b is an example diagram of an image feature information data segment according to an embodiment of this application.

FIG. 5c is an example diagram of a user defined information data segment according to an embodiment of this application.

FIG. 6a is an example diagram of encapsulating an image file in a static format according to an embodiment of this application.

FIG. 6b is an example diagram of encapsulating an image file in a dynamic format according to an embodiment of this application.

FIG. 7a is another example diagram of encapsulating an image file in a static format according to an embodiment of this application.

FIG. 7b is another example diagram of encapsulating an image file in a dynamic format according to an embodiment of this application.

FIG. 8a is an example diagram of frame header information according to an embodiment of this application.

FIG. 8b is an example diagram of image frame header information according to an embodiment of this application.

FIG. 8c is an example diagram of transparent channel frame header information according to an embodiment of this application.

FIG. 9 is a schematic flowchart of another image file processing method according to an embodiment of this application.

FIG. 10 is a schematic flowchart of another image file processing method according to an embodiment of this application.

FIG. 11 is a schematic flowchart of another image file processing method according to an embodiment of this application.

FIG. 12 is a schematic flowchart of another image file processing method according to an embodiment of this application.

FIG. 13 is a schematic flowchart of another image file processing method according to an embodiment of this application.

FIG. 14a is a schematic structural diagram of an encoding apparatus according to an embodiment of this application.

FIG. 14b is a schematic structural diagram of an encoding apparatus according to an embodiment of this application.

FIG. 14c is a schematic structural diagram of an encoding apparatus according to an embodiment of this application.

FIG. 14d is a schematic structural diagram of an encoding apparatus according to an embodiment of this application.

FIG. 15 is a schematic structural diagram of another encoding apparatus according to an embodiment of this application.

FIG. 16a is a schematic structural diagram of a decoding apparatus according to an embodiment of this application.

FIG. 16b is a schematic structural diagram of a decoding apparatus according to an embodiment of this application.

FIG. 16c is a schematic structural diagram of a decoding apparatus according to an embodiment of this application.

FIG. 16d is a schematic structural diagram of a decoding apparatus according to an embodiment of this application.

FIG. 16e is a schematic structural diagram of a decoding apparatus according to an embodiment of this application.

FIG. 17 is a schematic structural diagram of another decoding apparatus according to an embodiment of this application.

FIG. 18 is a schematic structural diagram of an image file processing apparatus according to an embodiment of this application.

FIG. 19 is a schematic structural diagram of another image file processing apparatus according to an embodiment of this application.

FIG. 20 is a schematic structural diagram of another image file processing apparatus according to an embodiment of this application.

FIG. 21 is a schematic structural diagram of another image file processing apparatus according to an embodiment of this application.

FIG. 22 is a system architecture diagram of an image file processing system according to an embodiment of this application.

FIG. 23 is an example diagram of an encoding module according to an embodiment of this application.

FIG. 24 is an example diagram of a decoding module according to an embodiment of this application.

FIG. 25 is a schematic structural diagram of a terminal device according to an embodiment of this application.

### DESCRIPTION OF EMBODIMENTS

The following clearly and completely describes the technical solutions in the embodiments of this application with reference to the accompanying drawings in the embodiments of this application. Apparently, the described embodiments are merely some but not all of the embodiments of this application. All other embodiments obtained by a person of ordinary skill in the art based on the embodiments of this application without creative efforts shall fall within the protection scope of this application.

Generally, when a large quantity of image files need to be transmitted, to reduce bandwidth or storage costs, a method is to reduce quality of the image file, for example, reduce quality of an image file in a Joint Photographic Experts Group (jpeg) format from jpeg80 to jpeg70 or even lower; however, image file quality is also greatly decreased, and user experience is greatly affected. Another method is to use a more efficient image file compression method. Current mainstream image file formats mainly include jpeg, Portable Network Graphic (png), Graphics Interchange (gif), and the like. All the formats have a problem of low compression efficiency if quality of an image file needs to be ensured.

In view of this, some embodiments of this application provide an image file processing method and apparatus, and a storage medium, to encode RGB data and transparency data respectively by using video encoding modes, thereby improving a compression ratio of an image file and ensuring quality of the image file. In the embodiments of this application, when a first image is RGBA data, an encoding apparatus obtains RGBA data corresponding to a first image in an image file, and separates the RGBA data to obtain RGB data and transparency data of the first image; encodes the RGB data of the first image according to a first video encoding mode, to generate first stream data; encodes the transparency data of the first image according to a second video encoding mode, to generate second stream data; and writes the first stream data and the second stream data into a stream data segment. In this way, through encoding by using the video encoding modes, a compression ratio of the image file can be improved, and a size of the image file can be reduced, so that a picture loading speed can be increased, and network transmission bandwidth and storage costs can be reduced. In addition, the RGB data and the transparency data in the image file are encoded respectively, to use the video encoding modes and reserve the transparency data in the image file, thereby ensuring quality of the image file.

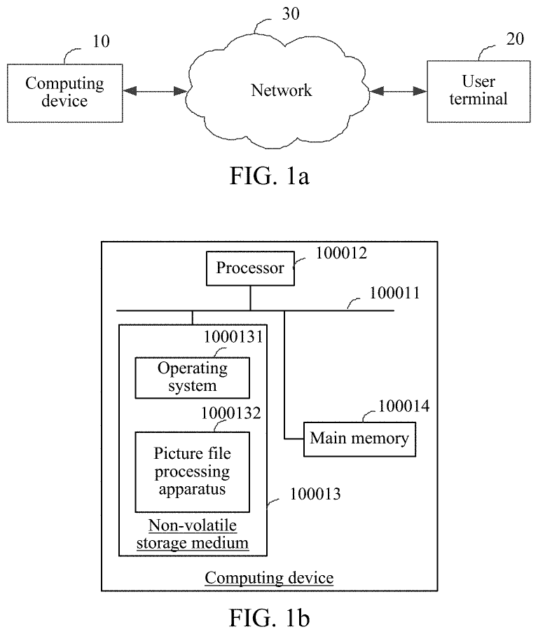

FIG. 1a is a schematic diagram of an implementation environment of an image file processing method according to an embodiment of this application. A computing device 10 is configured to implement an image file processing method provided in any embodiment of this application. The computing device 10 is connected to a user terminal 20 through a network 30, and the network 30 may be a wired network or a wireless network.

FIG. 1b is a schematic diagram of an internal structure of the computing device 10 for implementing an image file processing method according to an embodiment of this application. Referring to FIG. 1b, the computing device 10 includes a processor 100012, a non-volatile storage medium 100013, and a main memory 100014 that are connected by using a system bus 100011. The non-volatile storage medium 100013 in the computing device 10 stores an operating system 1000131, and further stores an image file processing apparatus 1000132. The image file processing apparatus 1000132 is configured to implement an image file processing method provided in any embodiment of this application. The processor 100012 in the computing device 10 is configured to provide computing and control capabilities, to support running of the entire terminal device. The main memory 100014 in the computing device 10 provides an environment for the image file processing apparatus in the non-volatile storage medium 100013. The main memory 100014 may store a computer-readable instruction. When the computer-readable instruction is executed by the processor 100012, the processor 100012 is caused to perform the image file processing method provided in any embodiment of this application. The computing device 10 may be a terminal or a server. The terminal may be a personal computer (PC) or a mobile electronic device. The mobile electronic device includes at least one of a mobile phone, a tablet computer, a personal digital assistant, a wearable device, or the like. The server may be implemented by using an independent server or a server cluster including a plurality of servers. A person skilled in the art may understand that, the structure shown in FIG. 1b is merely a block diagram of a partial structure related to the solution in this application, and does not constitute a limitation to the computing device to which the solution in this application is applied. Specifically, the computing device may include more components or fewer components than those shown in FIG. 1b, or some components may be combined, or a different component deployment may be used.

FIG. 1c is a schematic flowchart of an image file processing method according to an embodiment of this application. The method may be performed by the foregoing computing device. As shown in FIG. 1c, it is assumed that the computing device is a terminal device, and the method in this embodiment of this application may include step 101 to step 104.

Step 101: Obtain RGBA data corresponding to a first image in an image file, and separate the RGBA data to obtain RGB data and transparency data of the first image.

Specifically, an encoding apparatus run on the terminal device obtains the RGBA data corresponding to the first image in the image file, and separates the RGBA data to obtain the RGB data and the transparency data of the first image. Data corresponding to the first image is the RGBA data. The RGBA data is a color space representing red, green, blue, and transparency information (Alpha). The RGBA data corresponding to the first image is separated into the RGB data and the transparency data. The RGB data is color data included in the RGBA data, and the transparency data is transparency data included in the RGBA data.

For example, if the data corresponding to the first image is the RGBA data, because the first image is formed by many pixels, and each pixel corresponds to one piece of RGBA data, the first image formed by N pixels includes N pieces of RGBA data. A form of the RGBA data is as follows:

RGBA RGBA RGBA RGBA RGBA RGBA . . . RGBA

Therefore, according to this embodiment of this application, the encoding apparatus needs to separate the RGBA data of the first image, to obtain the RGB data and the transparency data of the first image, for example, perform a separation operation on the foregoing first image formed by the N pixels, and then obtain RGB data and transparency data of each of the N pixels. Forms of the RGB data and the transparency data are as follows:

RGB RGB RGB RGB RGB RGB . . . RGB
A A A A A A . . . A

Further, after the RGB data and the transparency data of the first image are obtained, step 102 and step 103 are performed respectively.

Step 102: Encode the RGB data of the first image according to a first video encoding mode, to generate first stream data.

Specifically, the encoding apparatus encodes the RGB data of the first image according to the first video encoding mode, to generate the first stream data. The first image may be a frame of image included in an image file in a static format; or the first image may be any one of a plurality of frames of images included in an image file in a dynamic format.

Step 103: Encode the transparency data of the first image according to a second video encoding mode, to generate second stream data.

Specifically, the encoding apparatus encodes the transparency data of the first image according to the second video encoding mode, to generate the second stream data.

For step 102 and step 103, the first video encoding mode or the second video encoding mode may include, but is not limited to, an intra-frame prediction (I) frame encoding mode and an inter-frame prediction (P) frame encoding mode. An I frame indicates a key frame, and when I-frame data is decoded, only a current frame of data is required to reconstruct a complete image. A complete image can be reconstructed by a P frame with reference to a previous encoded frame. A video encoding mode used for each frame of image in the image file in the static format or the image file in the dynamic format is not limited in this embodiment of this application.

For example, for the image file in the static format, because the image file in the static format includes only one frame of image, namely, the first image in this embodiment of this application, I-frame encoding is performed on the RGB data and the transparency data of the first image. For another example, for the image file in the dynamic format, the image file in the dynamic format generally includes at least two frames of images. Therefore, in this embodiment of this application, I-frame encoding is performed on RGB data and transparency data of the first frame of image in the image file in the dynamic format; and I-frame encoding or P-frame encoding may be performed on RGB data and transparency data of a non-first frame of image.

Step 104: Write the first stream data and the second stream data into a stream data segment of the image file.

Specifically, the encoding apparatus writes, into the stream data segment of the image file, the first stream data generated from the RGB data of the first image, and the second stream data generated from the transparency data of the first image. The first stream data and the second stream data are complete stream data corresponding to the first image, that is, the RGBA data of the first image can be obtained by decoding the first stream data and the second stream data.

It should be noted that, step 102 and step 103 are not limited to a particular order during execution.

It should be noted that, in this embodiment of this application, the RGBA data input before encoding may be obtained by decoding image files in various formats. A format of the image file may be any one of formats such as JPEG, Bitmap (BMP), PNG, Animated Portable Network Graphics (APNG), and GIF. A format of the image file before encoding is not limited in this embodiment of this application.

It should be noted that, the first image in this embodiment of this application is the RGBA data including the RGB data and the transparency data. However, when the first image includes only the RGB data, after obtaining the RGB data corresponding to the first image, the encoding apparatus may perform step 102 for the RGB data, to generate the first stream data, and determine the first stream data as complete stream data corresponding to the first image. In this way, the first image including only the RGB data can still be encoded by using the video encoding mode, to compress the first image.

In this embodiment of this application, when the first image is the RGBA data, the encoding apparatus obtains the RGBA data corresponding to the first image in the image file, and separates the RGBA data to obtain the RGB data and the transparency data of the first image; encodes the RGB data of the first image according to the first video encoding mode, to generate the first stream data; encodes the transparency data of the first image according to the second video encoding mode, to generate the second stream data; and writes the first stream data and the second stream data into the stream data segment. In this way, through encoding by using the video encoding modes, a compression ratio of the image file can be improved, and a size of the image file can be reduced, so that a picture loading speed can be increased, and network transmission bandwidth and storage costs can be reduced. In addition, the RGB data and the transparency data in the image file are encoded respectively, to use the video encoding modes and reserve the transparency data in the image file, thereby ensuring quality of the image file.

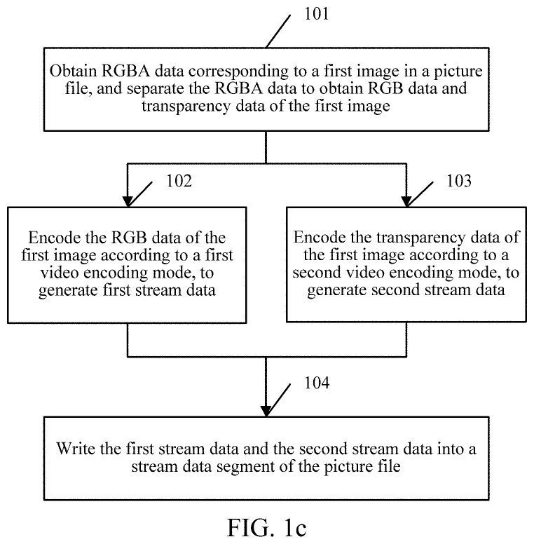

FIG. 2 is a schematic flowchart of another image file processing method according to an embodiment of this application. The method may be performed by the foregoing computing device. As shown in FIG. 2, it is assumed that the computing device is a terminal device, and the method in this embodiment of this application may include step 201 to step 207. This embodiment of this application is described by using an image file in a dynamic format as an example. Refer to the following detailed descriptions.

Step 201: Obtain RGBA data corresponding to a first image corresponding to a k^{th} frame in an image file in a dynamic format, and separate the RGBA data to obtain RGB data and transparency data of the first image.

Specifically, an encoding apparatus run on the terminal device obtains the to-be-encoded image file in the dynamic format. The image file in the dynamic format includes at least two frames of images. The encoding apparatus obtains the first image corresponding to the k^{th} frame in the image file in the dynamic format. The k^{th} frame may be any one of the at least two frames of images, where k is a positive integer greater than 0.

According to some embodiments of this application, the encoding apparatus may perform encoding in an order of images corresponding to all frames in the image file in the dynamic format, that is, may first obtain an image corresponding to the first frame in the image file in the dynamic format. An order in which the encoding apparatus obtains an image included in the image file in the dynamic format is not limited in this embodiment of this application.

Further, if data corresponding to the first image is the RGBA data, the RGBA data is a color space representing Red, Green, Blue, and Alpha. The RGBA data corresponding to the first image is separated into the RGB data and the transparency data. Specifically, because the first image is formed by many pixels, and each pixel corresponds to one piece of RGBA data, the first image formed by N pixels includes N pieces of RGBA data. A form of the RGBA data is as follows:

RGBA RGBA RGBA RGBA RGBA RGBA . . . RGBA

Therefore, the encoding apparatus needs to separate the RGBA data of the first image, to obtain the RGB data and the transparency data of the first image, for example, perform a separation operation on the foregoing first image formed by the N pixels, and then obtain RGB data and transparency data of each of the N pixels. Forms of the RGB data and the transparency data are as follows:

RGB RGB RGB RGB RGB RGB . . . RGB
A A A A A A . . . A

Further, after the RGB data and the transparency data of the first image are obtained, step 202 and step 203 are performed respectively.

Step 202: Encode the RGB data of the first image according to a first video encoding mode, to generate first stream data.

Specifically, the encoding apparatus encodes the RGB data of the first image according to the first video encoding mode, to generate the first stream data. The RGB data is color data obtained by separating the RGBA data corresponding to the first image.

Step 203: Encode the transparency data of the first image according to a second video encoding mode, to generate second stream data.

Specifically, the encoding apparatus encodes the transparency data of the first image according to the second video encoding mode, to generate the second stream data. The transparency data is obtained by separating the RGBA data corresponding to the first image.

It should be noted that, step 202 and step 203 are not limited to a particular order during execution.

Step 204: Write the first stream data and the second stream data into a stream data segment of the image file.

Specifically, the encoding apparatus writes, into the stream data segment of the image file, the first stream data generated from the RGB data of the first image, and the second stream data generated from the transparency data of the first image. The first stream data and the second stream data are complete stream data corresponding to the first image, that is, the RGBA data of the first image can be obtained by decoding the first stream data and the second stream data.

Step 205: Determine whether the k^{th} frame is the last frame in the image file in the dynamic format.

Specifically, the encoding apparatus determines whether the k^{th} frame is the last frame in the image file in the dynamic format. If the k^{th} frame is the last frame, it indicates that encoding of the image file in the dynamic format is completed, and then step 207 is performed. If the k^{th} frame is not the last frame, it indicates that there is an image that is not encoded in the image file in the dynamic format, and then step 206 is performed.

Step 206: Update k if the k^{th} frame is not the last frame in the image file in the dynamic format, and trigger execution of the operation of obtaining RGBA data corresponding to a first image corresponding to a k^{th} frame in an image file in a dynamic format, and separating the RGBA data to obtain RGB data and transparency data of the first image.

Specifically, if determining that the k^{th} frame is not the last frame in the image file in the dynamic format, the encoding apparatus encodes an image corresponding to a next frame, that is, updates k by using a value of (k+1), and after updating k, triggers execution of the operation of obtaining RGBA data corresponding to a first image corresponding to a k^{th} frame in an image file in a dynamic format, and separating the RGBA data to obtain RGB data and transparency data of the first image.

It may be understood that, an image obtained by using updated k and an image obtained before k is updated are not an image corresponding to the same frame. For ease of description, herein, the image corresponding to the k^{th} frame before k is updated is set as the first image, and the image corresponding to the k^{th} frame after k is updated is set as a second image, to facilitate distinguishing.

In some embodiments of this application, when step 202 to step 204 are performed for the second image, RGBA data corresponding to the second image includes RGB data and transparency data. The encoding apparatus encodes the RGB data of the second image according to a third video encoding mode, to generate third stream data; encodes the transparency data of the second image according to a fourth video encoding mode, to generate fourth stream data; and writes the third stream data and the fourth stream data into a stream data segment of the image file.

For step 202 and step 203, the first video encoding mode, the second video encoding mode, the third video encoding mode, or the fourth video encoding mode above may include, but is not limited to, an I-frame encoding mode and a P-frame encoding mode. An I frame indicates a key frame, and when I-frame data is decoded, only a current frame of data is required to reconstruct a complete image. A complete image can be reconstructed by a P frame with reference to a previous encoded frame. A video encoding mode used for RGB data and transparency data in each frame of image in the image file in the dynamic format is not limited in this embodiment of this application. For example, RGB data and transparency data in the same frame of image may be encoded according to different video encoding modes; or may be encoded according to the same video encoding mode. RGB data in different frames of images may be encoded according to different video encoding modes; or may be encoded according to the same video encoding mode. Transparency data in different frames of images may be encoded according to different video encoding modes; or may be encoded according to the same video encoding mode.

It should be further noted that, the image file in the dynamic format includes a plurality of stream data segments. In some embodiments of this application, one frame of image corresponds to one stream data segment. Alternatively, in some other embodiments of this application, one piece of stream data corresponds to one stream data segment. Therefore, the stream data segment into which the first stream data and the second stream data are written is different from the stream data segment into which the third stream data and the fourth stream data are written.

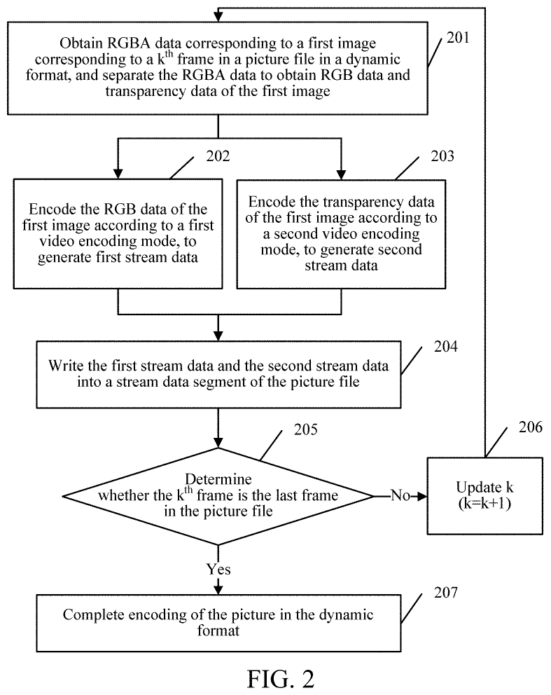

For example, also refer to FIG. 3 that is an example diagram of a plurality of frames of images included in an image file in a dynamic format according to an embodiment of this application. As shown in FIG. 3, FIG. 3 is described for an image file in a dynamic format. The image file in the dynamic format includes a plurality of frames of images, for example, an image corresponding to the first frame, an image corresponding to the second frame, an image corresponding to the third frame, and an image corresponding to the fourth frame, and the image corresponding to each frame includes RGB data and transparency data. In some embodiments of this application, the encoding apparatus may respectively encode, according to the I-frame encoding mode, the RGB data and the transparency data in the image corresponding to the first frame, and encode, according to the P-frame encoding mode, images respectively corresponding to other frames such as the second frame, the third frame, and the fourth frame, for example, needs to encode, according to the P-frame encoding mode with reference to the RGB data in the image corresponding to the first frame, the RGB data in the image corresponding to the second frame, and needs to encode, according to the P-frame encoding mode with reference to the transparency data in the image corresponding to the first frame, the transparency data in the image corresponding to the second frame. The rest can be deduced by analogy, and other frames such as the third frame and the fourth frame may be encoded by using the P-frame encoding mode with reference to the second frame.

It should be noted that, the foregoing merely shows that the image file in the dynamic format is encoded in an optional encoding solution; or the encoding apparatus may further encode each of the first frame, the second frame, the third frame, the fourth frame, and the like by using the I-frame encoding mode.

Step 207: Complete, if the k^{th} frame is the last frame in the image file in the dynamic format, encoding of the image file in the dynamic format.

Specifically, if the encoding apparatus determines that the k^{th} frame is the last frame in the image file in the dynamic format, it indicates that encoding of the image file in the dynamic format is completed.

In some embodiments of this application, the encoding apparatus may generate frame header information for stream data generated from an image corresponding to each frame, and generate image header information for the image file in the dynamic format. In this way, whether the image file includes the transparency data may be determined by using the image header information, and then whether to obtain only the first stream data generated from the RGB data or obtain the first stream data generated from the RGB data and the second stream data generated from the transparency data in a decoding process may be determined.

It should be noted that, the image corresponding to each frame in the image file in the dynamic format in this embodiment of this application is RGBA data including RGB data and transparency data. However, when the image corresponding to each frame in the image file in the dynamic format includes only RGB data, the encoding apparatus may perform step 202 for the RGB data of each frame of image, to generate the first stream data and write the first stream data into the stream data segment of the image file, and finally determine the first stream data as complete stream data corresponding to the first image. In this way, the first image including only the RGB data can still be encoded by using the video encoding mode, to compress the first image.

It should be further noted that, in this embodiment of this application, the RGBA data input before encoding may be obtained by decoding image files in various dynamic formats. The dynamic format of the image file may be any one of formats such as APNG and GIF. The dynamic format of the image file before encoding is not limited in this embodiment of this application.

In this embodiment of this application, when the first image in the image file in the dynamic format is the RGBA data, the encoding apparatus obtains the RGBA data corresponding to the first image in the image file, and separates the RGBA data to obtain the RGB data and the transparency data of the first image; encodes the RGB data of the first image according to the first video encoding mode, to generate the first stream data; encodes the transparency data of the first image according to the second video encoding mode, to generate the second stream data; and writes the first stream data and the second stream data into the stream data segment. In addition, the image corresponding to each frame in the image file in the dynamic format can be encoded according to a manner of the first image. In this way, through encoding by using the video encoding modes, a compression ratio of the image file can be improved, and a size of the image file can be reduced, so that a picture loading speed can be increased, and network transmission bandwidth and storage costs can be reduced. In addition, the RGB data and the transparency data in the image file are encoded respectively, to use the video encoding modes and reserve the transparency data in the image file, thereby ensuring quality of the image file.

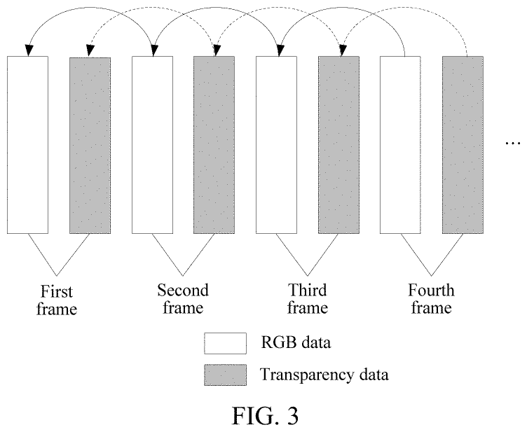

FIG. 4a is a schematic flowchart of another image file processing method according to an embodiment of this application, The method may be performed by the foregoing computing device. As shown in FIG. 4a, it is assumed that the computing device is a terminal device, and the method in this embodiment of this application may include step 301 to step 307.

Step 301: Obtain RGBA data corresponding to a first image in an image file, and separate the RGBA data to obtain RGB data and transparency data of the first image.

Specifically, an encoding apparatus run on the terminal device obtains the RGBA data corresponding to the first image in the image file, and separates the RGBA data to obtain the RGB data and the transparency data of the first image. Data corresponding to the first image is the RGBA data. The RGBA data is a color space representing Red, Green, Blue, and Alpha. The RGBA data corresponding to the first image is separated into the RGB data and the transparency data. The RGB data is color data included in the RGBA data, and the transparency data is transparency data included in the RGBA data.

For example, if the data corresponding to the first image is the RGBA data, because the first image is formed by many pixels, and each pixel corresponds to one piece of RGBA data, the first image formed by N pixels includes N pieces of RGBA data. A form of the RGBA data is as follows:

RGBA RGBA RGBA RGBA RGBA RGBA . . . RGBA

Therefore, according to this embodiment of this application, the encoding apparatus needs to separate the RGBA data of the first image, to obtain the RGB data and the transparency data of the first image, for example, perform a separation operation on the foregoing first image formed by the N pixels, and then obtain RGB data and transparency data of each of the N pixels. Forms of the RGB data and the transparency data are as follows:

RGB RGB RGB RGB RGB RGB . . . RGB
A A A A A A . . . A

Further, after the RGB data and the transparency data of the first image are obtained, step 302 and step 303 are performed respectively.

Step 302: Encode the RGB data of the first image according to a first video encoding mode, to generate first stream data.

Specifically, the encoding apparatus encodes the RGB data of the first image according to the first video encoding mode, to generate the first stream data. The first image may be a frame of image included in an image file in a static format; or the first image may be any one of a plurality of frames of images included in an image file in a dynamic format.

In some embodiments of this application, a specific process in which the encoding apparatus encodes the RGB data of the first image according to the first video encoding mode and generates the first stream data is: converting the RGB data of the first image into first YUV data; and encoding the first YUV data according to the first video encoding mode, to generate the first stream data. In some embodiments of this application, the encoding apparatus may convert the RGB data into the first YUV data according to a preset YUV color space format. For example, the preset YUV color space format may include, but is not limited to, YUV420, YUV422, and YUV444.

Step 303: Encode the transparency data of the first image according to a second video encoding mode, to generate second stream data.

Specifically, the encoding apparatus encodes the transparency data of the first image according to the second video encoding mode, to generate the second stream data.

The first video encoding mode in step 302 or the second video encoding mode in step 303 may include, but is not limited to, an I-frame encoding mode and a P-frame encoding mode. An I frame indicates a key frame, and when I-frame data is decoded, only a current frame of data is required to reconstruct a complete image. A complete image can be reconstructed by a P frame with reference to a previous encoded frame. A video encoding mode used for each frame of image in the image file in the static format or the image file in the dynamic format is not limited in this embodiment of this application.

For example, for the image file in the static format, because the image file in the static format includes only one frame of image, namely, the first image in this embodiment of this application, I-frame encoding is performed on the RGB data and the transparency data of the first image. For another example, for the image file in the dynamic format, the image file in the dynamic format includes at least two frames of images. Therefore, in this embodiment of this application, I-frame encoding is performed on RGB data and transparency data of the first frame of image in the image file in the dynamic format; and I-frame encoding or P-frame encoding may be performed on RGB data and transparency data of a non-first frame of image.

In some embodiments of this application, a specific process in which the encoding apparatus encodes the transparency data of the first image according to the second video encoding mode and generates the second stream data is: converting the transparency data of the first image into second YUV data; and encoding the second YUV data according to the second video encoding mode, to generate the second stream data.

The converting, by the encoding apparatus, the transparency data of the first image into second YUV data is specifically: in some embodiments of this application, setting, by the encoding apparatus, the transparency data of the first image as a Y component in the second YUV data, and skipping setting a U component and a V component in the second YUV data; or in some other embodiments of this application, setting the transparency data of the first image as a Y component in the second YUV data, and setting a U component and a V component in the second YUV data as preset data. In this embodiment of this application, the encoding apparatus may convert the transparency data into the second YUV data according to a preset YUV color space format, where for example, the preset YUV color space format may include, but is not limited to, YUV400, YUV420, YUV422, and YUV444, and may set the U component and the V component according to the YUV color space format.

Further, if data corresponding to the first image is the RGBA data, the encoding apparatus obtains the RGB data and the transparency data of the first image by separating the RGBA data of the first image. Then, an example is used to describe conversion of the RGB data of the first image into the first YUV data and conversion of the transparency data of the first image into the second YUV data. An example in which the first image includes four pixels is used for description. The RGB data of the first image is RGB data of the four pixels, the transparency data of the first image is transparency data of the four pixels, and for a specific process of converting the RGB data and the transparency data of the first image, refer to exemplary descriptions of FIG. 4b to FIG. 4d.

FIG. 4b is an example diagram of converting RGB data into YUV data according to an embodiment of this application. As shown in FIG. 4b, the RGB data includes RGB data of four pixels, and the RGB data of the four pixels is converted according to a color space conversion mode. If the YUV color space format is YUV444, RGB data of one pixel can be converted into one piece of YUV data according to a corresponding conversion formula. In this way, the RGB data of the four pixels are converted into four pieces of YUV data, and the first YUV data includes the four pieces of YUV data. Different YUV color space formats correspond to different conversion formulas.

Further, FIG. 4c and FIG. 4d each are an example diagram of converting transparency data into YUV data according to an embodiment of this application. First, as shown in FIGS. 4c and 4d, the transparency data includes A data of four pixels, where A indicates transparency, and the transparency data of each pixel is set as a Y component. Then, a YUV color space format is determined, to determine the second YUV data.

If the YUV color space format is YUV400, U and V components are not set, and Y components of the four pixels are determined as the second YUV data of the first image (as shown in FIG. 4c).

If the YUV color space format is a format in which U and V components exist other than YUV400, the U and V components are set as preset data, as shown in FIG. 4d. In FIG. 4d, conversion is performed by using the color space format of YUV444, that is, a U component and a V component that are preset data is set for each pixel. In addition, for another example, if the YUV color space format is YUV422, a U component and a V component that are preset data are set for every two pixels, or if the YUV color space format is YUV420, a U component and a V component that are preset data are set for every four pixels. Other formats can be deduced by analogy, and details are not described herein again. Finally, the YUV data of the four pixels is determined as the second YUV data of the first image.

It should be noted that, step 302 and step 303 are not limited to a particular order during execution.

Step 304: Write the first stream data and the second stream data into a stream data segment of the image file.

Specifically, the encoding apparatus writes, into the stream data segment of the image file, the first stream data generated from the RGB data of the first image, and the second stream data generated from the transparency data of the first image. The first stream data and the second stream data are complete stream data corresponding to the first image, that is, the RGBA data of the first image can be obtained by decoding the first stream data and the second stream data.

Step 305: Generate image header information and frame header information that correspond to the image file.

Specifically, the encoding apparatus generates the image header information and the frame header information that correspond to the image file. The image file may be an image file in a static format, that is, includes only the first image; or the image file is an image file in a dynamic format, that is, includes the first image and another image. Regardless of whether the image file is the image file in the static format or the image file in the dynamic format, the encoding apparatus needs to generate the image header information corresponding to the image file. The image header information includes image feature information indicating whether there is transparency data in the image file, so that a decoding apparatus determines, by using the image feature information, whether the image file includes the transparency data, to determine how to obtain stream data and whether the obtained stream data includes the second stream data generated from the transparency data.

Further, the frame header information is used to indicate the stream data segment of the image file, so that the decoding apparatus determines, by using the frame header information, the stream data segment from which the stream data can be obtained, thereby decoding the stream data.

It should be noted that, in this embodiment of this application, an order of step 305 of generating image header information and frame header information that correspond to the image file and step 302, step 303, and step 304 is not limited.

Step 306: Write the image header information into an image header information data segment of the image file.

Specifically, the encoding apparatus writes the image header information into an image header information data segment of the image file. The image header information includes an image file identifier, a decoder identifier, a version number, and the image feature information; the image file identifier is used to indicate a type of the image file; the decoder identifier is used to indicate an identifier of an encoding/decoding standard used for the image file; and the version number is used to indicate a profile of the encoding/decoding standard used for the image file.

In some embodiments of this application, the image header information may further include a user defined information data segment. The user defined information data segment includes a user defined information start code, a length of the user defined information data segment, and user defined information. The user defined information includes Exchangeable Image File (EXIF) information, for example, an aperture, a shutter, white balance, the International Organization for Standardization (ISO), a focal length, a date, a time, and the like during photographing, a photographing condition, a camera brand, a model, color encoding, sound recorded during photographing, Global Positioning System data, a thumbnail, and the like. The user defined information includes information that can be defined and set by a user, This is not limited in this embodiment of this application.

The image feature information further includes an image feature information start code, an image feature information data segment length, whether the image file is an image file in a static format, whether the image file is the image file in the dynamic format, whether the image file is losslessly encoded, a YUV color space value domain used for the image file, a width of the image file, a height of the image file, and a frame quantity used for indication if the image file is the image file in the dynamic format. In some embodiments of this application, the image feature information may further include a YUV color space format used for the image file.

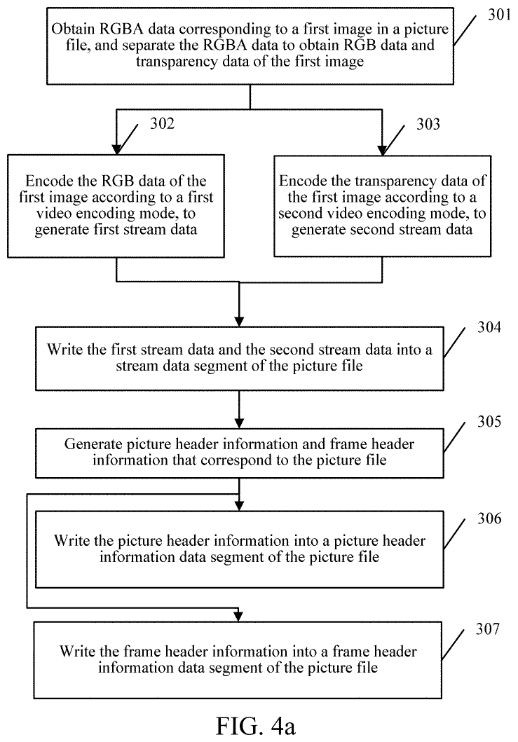

For example, FIG. 5a is an example diagram of image header information according to an embodiment of this application. As shown in FIG. 5a, image header information of an image file includes three parts, namely, an image sequence header data segment, an image feature information data segment, and a user defined information data segment.

The image sequence header data segment includes an image file identifier, a decoder identifier, a version number, and the image feature information.

The image file identifier (image_identifier) is used to indicate a type of the image file, and may be indicated by a preset identifier. For example, the image file identifier occupies four bytes. For example, the image file identifier is a bit string ‘AVSP’, used to indicate that this is an AVS image file.

The decoder identifier is used to indicate an identifier of an encoding/decoding standard used to compress the current image file, and is, for example, indicated by using four bytes, or may be explained as indicating a model of a decoder kernel used for current picture decoding. When an AVS2 kernel is used, the decoder identifier code_id is ‘AVS2’.

The version number is used to indicate a profile of an encoding/decoding standard indicated by a compression standard identifier. For example, profiles may include a baseline profile, a main profile, and an extended profile. For example, an 8-bit unsigned number identifier is used. As shown in Table 1, a type of the version number is provided.

TABLE 1

| Value of a version number | Profile |
|---|---|
| ‘B’ | Base Profile |
| ‘M’ | Main Profile |
| ‘H’ | High Profile |

Also refer to FIG. 5b that is an example diagram of an image feature information data segment according to an embodiment of this application. As shown in FIG. 5b, the image feature information data segment includes an image feature information start code, an image feature information data segment length, whether there is an alpha channel flag (namely, an image transparency flag shown in FIG. 5b), a dynamic image flag, a YUV color space format, a lossless mode flag, a YUV color space value domain flag, a reserved bit, an image width, an image height, and a frame quantity. Refer to the following detailed descriptions.

The image feature information start code is a field used to indicate a start location of the image feature information data segment of the image file, and is, for example, indicated by using one byte, and a field D0 is used.

The image feature information data segment length indicates a quantity of bytes occupied by the image feature information data segment, and is, for example, indicated by using two bytes. For example, for the image file in the dynamic format, the image feature information data segment in FIG. 5b occupies nine bytes in total, and 9 may be filled in; and for the image file in the static format, the image feature information data segment in FIG. 5b occupies 12 bytes in total, and 12 may be filled in.

The image transparency flag is used to indicate whether an image in the image file carries transparency data, and is, for example, indicated by using one bit. 0 indicates that the image in the image file carries no transparency data, and 1 indicates that the image in the image file carries transparency data. It may be understood that, whether there is an alpha channel and whether transparency data is included represent the same meaning.

The dynamic image flag is used to indicate whether the image file is the image file in the dynamic format or the image file in the static format, and is, for example, indicated by using one bit. 0 indicates that the image file is the image file in the static format, and 1 indicates that the image file is the image file in the dynamic format.

The YUV color space format is used to indicate a chrominance component format used to convert the RGB data of the image file into the YUV data, and is, for example, indicated by using two bits, as shown in the following Table 2.

TABLE 2

| Value of a YUV_color space format | YUV color space format |
|---|---|
| 00 | 4:0:0 |
| 01 | 4:2:0 |
| 10 | 4:2:2 (reserved) |
| 11 | 4:4:4 |

The lossless mode flag is used to indicate whether lossless encoding or lossy compression is used, and is, for example, indicated by using one bit. 0 indicates lossy encoding, and 1 indicates lossless encoding. If the RGB data of the image file is directly encoded by using a video encoding mode, it indicates that lossless encoding is used; and if the RGB data of the image file is first converted into YUV data, and then the YUV data is encoded, it indicates that lossy encoding is used.

The YUV color space value domain flag is used to indicate that a YUV color space value domain range conforms to the ITU-R BT.601 standard, and is, for example, indicated by using one bit. 1 indicates that a value domain range of the Y component is [16, 235] and a value domain range of the U and V components is [16, 240]; and 0 indicates that a value domain range of the Y component and the U and V components is [0, 255].

The reserved bit is a 10-bit unsigned integer. Redundant bits in a byte are set as reserved bits.

The image width is used to indicate a width of each image in the image file, and may be, for example, indicated by using two bytes if the image width ranges from 0 to 65535.

The image height is used to indicate a height of each image in the image file, and may be, for example, indicated by using two bytes if the image height ranges from 0 to 65535.

The image frame quantity exists only in a case of the image file in the dynamic format, is used to indicate a total quantity of frames included in the image file, and is, for example, indicated by using three bytes.

Also refer to FIG. 5c that is an example diagram of a user defined information data segment according to an embodiment of this application. As shown in FIG. 5c, for details, refer to the following detailed descriptions.

The user defined information start code is a field used to indicate a start location of the user defined information, and is, for example, indicated by using one byte. For example, a bit string ‘0x000001BC’ identifies the beginning of the user defined information.

A user defined information data segment length indicates a data length of current user defined information, and is, for example, indicated by using two bytes.

The user defined information is used to write data that a user needs to import, for example, information such as EXIF, and a quantity of occupied bytes may be determined according to a length of the user defined information.

It should be noted that, the foregoing is merely exemplary description, and a name of each piece of information included in the image header information, a location of each piece of information in the image header information, and a quantity of bits occupied for indicating each piece of information are not limited in this embodiment of this application.

Step 307: Write the frame header information into a frame header information data segment of the image file.

Specifically, the encoding apparatus writes the frame header information into the frame header information data segment of the image file.

In some embodiments of this application, one frame of image in the image file corresponds to one piece of frame header information. Specifically, when the image file is the image file in the static format, the image file in the static format includes one frame of image, namely, the first image, and therefore, the image file in the static format includes one piece of frame header information. When the image file is the image file in the dynamic format, the image file in the dynamic format usually includes at least two frames of images, and one piece of frame header information is added to each of the at least two frames of images.

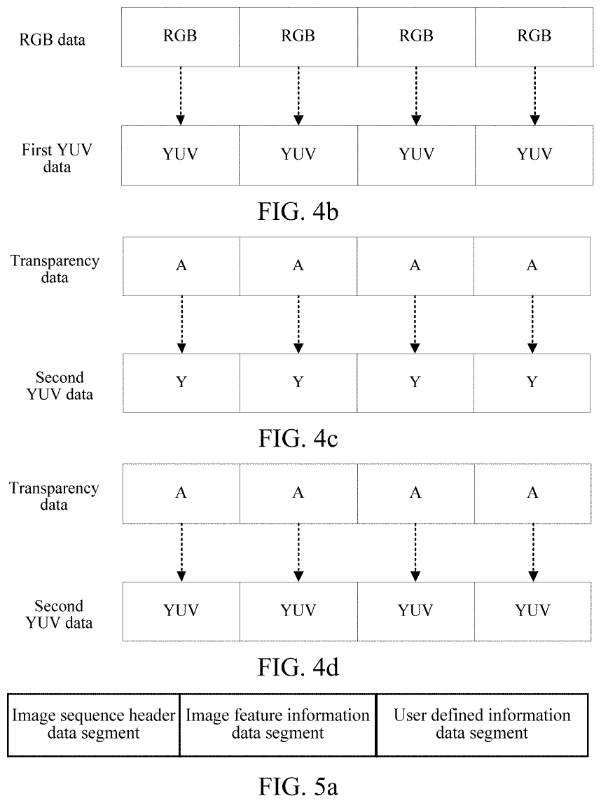

FIG. 6a is an example diagram of encapsulating an image file in a static format according to an embodiment of this application. As shown in FIG. 6a, the image file includes an image header information data segment, a frame header information data segment, and a stream data segment. A image file in the static format includes image header information, frame header information, and stream data that indicates an image in the image file. The stream data herein includes first stream data generated from RGB data of the frame of image and second stream data generated from transparency data of the frame of image. Each piece of information or data is written into a corresponding data segment. For example, the image header information is written into the image header information data segment; the frame header information is written into the frame header information data segment; and the stream data is written into the stream data segment. It should be noted that, because the first stream data and the second stream data in the stream data segment are obtained by using video encoding modes, the stream data segment may be described by using a video frame data segment. In this way, information written into the video frame data segment is the first stream data and the second stream data that are obtained by encoding the image file in the static format.

FIG. 6b is an example diagram of encapsulating an image file in a dynamic format according to an embodiment of this application. As shown in FIG. 6b, the image file includes an image header information data segment, a plurality of frame header information data segments, and a plurality of stream data segments. The image file in the dynamic format includes image header information, a plurality of pieces of frame header information, and stream data that indicates a plurality of frames of images. Stream data corresponding to one frame of image corresponds to one piece of frame header information. Stream data indicating each frame of image includes first stream data generated from RGB data of the frame of image and second stream data generated from transparency data of the frame of image. Each piece of information or data is written into a corresponding data segment. For example, the image header information is written into the image header information data segment; frame header information corresponding to the first frame is written into a frame header information data segment corresponding to the first frame; stream data corresponding to the first frame is written into a stream data segment corresponding to the first frame; and the rest can be deduced by analogy, to write frame header information corresponding to a plurality of frames to frame header information segments corresponding to the frames, and write stream data corresponding to the plurality of frames to stream data segments corresponding to the frames. It should be noted that, because the first stream data and the second stream data in the stream data segment are obtained by using video encoding modes, the stream data segment may be described by using a video frame data segment. In this way, information written into a video frame data segment corresponding to each frame of image is the first stream data and the second stream data that are obtained by encoding the frame of image.

In some other embodiments of this application, one piece of stream data in one frame of image in the image file corresponds to one piece of frame header information. Specifically, in a case of the image file in the static format, the image file in the static format includes one frame of image, namely, the first image, and the first image including the transparency data corresponds to two pieces of stream data that are respectively the first stream data and the second stream data. Therefore, the first stream data in the image file in the static format corresponds to one piece of frame header information, and the second stream data corresponds to the other piece of frame header information. In a case of the image file in the dynamic format, the image file in the dynamic format includes at least two frames of images, each frame of image including transparency data corresponds to two pieces of stream data that are respectively the first stream data and the second stream data, and one piece of frame header information is added to each of the first stream data and the second stream data of each frame of image.

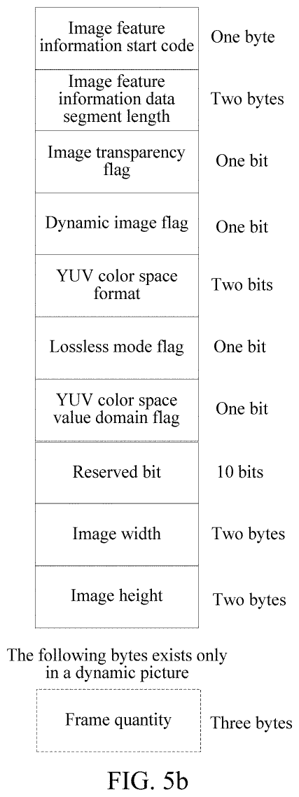

FIG. 7a is another example diagram of encapsulating an image file in a static format according to an embodiment of this application. To distinguish between frame header information corresponding to first stream data and frame header information corresponding to second stream data, distinguishing is performed herein by using image frame header information and transparent channel frame header information. The first stream data generated from RGB data corresponds to the image frame header information, and the second stream data generated from transparency data corresponds to the transparent channel frame header information. As shown in FIG. 7a, the image file includes an image header information data segment, an image frame header information data segment and a first stream data segment that correspond to the first stream data, and a transparent channel frame header information data segment and a second stream data segment that correspond to the second stream data. A image file in a static format includes image header information, two pieces of frame header information, and first stream data and second stream data that indicate one frame of image. The first stream data is generated from RGB data of the frame of image, and the second stream data is generated from transparency data of the frame of image. Each piece of information or data is written into a corresponding data segment. For example, image header information is written into the image header information data segment, the image frame header information corresponding to the first stream data is written into the image frame header information data segment corresponding to the first stream data; the first stream data is written into the first stream data segment; the transparent channel frame header information corresponding to the second stream data is written into the transparent channel frame header information data segment corresponding to the second stream data; and the second stream data is written into the second stream data segment. In some embodiments of this application, the image frame header information data segment and the first stream data segment that correspond to the first stream data may be set as an image frame data segment, and the transparent channel frame header information data segment and the second stream data segment that correspond to the second stream data may be set as a transparent channel frame data segment. Names of data segments and names of data segments obtained by combining the data segments are not limited in this embodiment of this application.

In some embodiments of this application, when one piece of stream data in one frame of image in the image file corresponds to one piece of frame header information, the encoding apparatus may arrange, in a preset order, the frame header information data segment and the first stream data segment that correspond to the first stream data, and the frame header information data segment and the second stream data segment that correspond to the second stream data. For example, a first stream data segment, a second stream data segment, and frame header information data segments corresponding to various pieces of stream data of one frame of image may be arranged according to the frame header information data segment and the first stream data segment that correspond to the first stream data, and the frame header information data segment and the second stream data segment that correspond to the second stream data. In this way, in a decoding process, the decoding apparatus can determine, in stream data segments indicated by two pieces of frame header information and two frame headers that indicate the frame of image, a stream data segment from which the first stream data can be obtained, and a stream data segment from which the second stream data can be obtained. It may be understood that, herein, the first stream data is stream data generated from the RGB data, and the second stream data is stream data generated from the transparency data.

FIG. 7b is another example diagram of encapsulating an image file in a dynamic format according to an embodiment of this application. To distinguish between frame header information corresponding to first stream data and frame header information corresponding to second stream data, distinguishing is performed herein by using image frame header information and transparent channel frame header information. The first stream data generated from RGB data corresponds to the image frame header information, and the second stream data generated from transparency data corresponds to the transparent channel frame header information. As shown in FIG. 7b, the image file includes an image header information data segment, a plurality of frame header information data segments, and a plurality of stream data segments. A image file in a dynamic format includes image header information, a plurality of pieces of frame header information, and stream data that indicates a plurality of frames of images. Each of first stream data and second stream data that correspond to one frame of image corresponds to one piece of frame header information. The first stream data is generated from RGB data of the frame of image, and the second stream data is generated from transparency data of the frame of image. Each piece of information or data is written into a corresponding data segment. For example, the image header information is written into the image header information data segment; image frame header information corresponding to first stream data in the first frame is written into an image frame header information data segment corresponding to the first stream data in the first frame; the first stream data corresponding to the first frame is written into a first stream data segment in the first frame; transparent channel frame header information corresponding to second stream data in the first frame is written into a transparent channel frame header information data segment corresponding to the second stream data in the first frame; the second stream data corresponding to the first frame is written into a second stream data segment in the first frame; and the rest can be deduced by analogy, to write frame header information corresponding to each piece of stream data in a plurality of frames into a frame header information data segment corresponding to corresponding stream data in each frame, and write each piece of stream data in the plurality of frames into a stream data segment corresponding to corresponding stream data in each frame. In some embodiments of this application, the image frame header information data segment and the first stream data segment that correspond to the first stream data may be set as an image frame data segment, and the transparent channel frame header information data segment and the second stream data segment that correspond to the second stream data may be set as a transparent channel frame data segment. Names of data segments and names of data segments obtained by combining the data segments are not limited in this embodiment of this application.

Further, the frame header information includes a frame header information start code and delay time information used for indication if the image file is the image file in the dynamic format. In some embodiments of this application, the frame header information further includes at least one of a frame header information data segment length and a stream data segment length of a stream data segment indicated by the frame header information. Further, in some embodiments of this application, the frame header information further includes specific information for distinguishing from another frame of image, for example, encoding area information, transparency information, and a color table. This is not limited in this embodiment of this application.

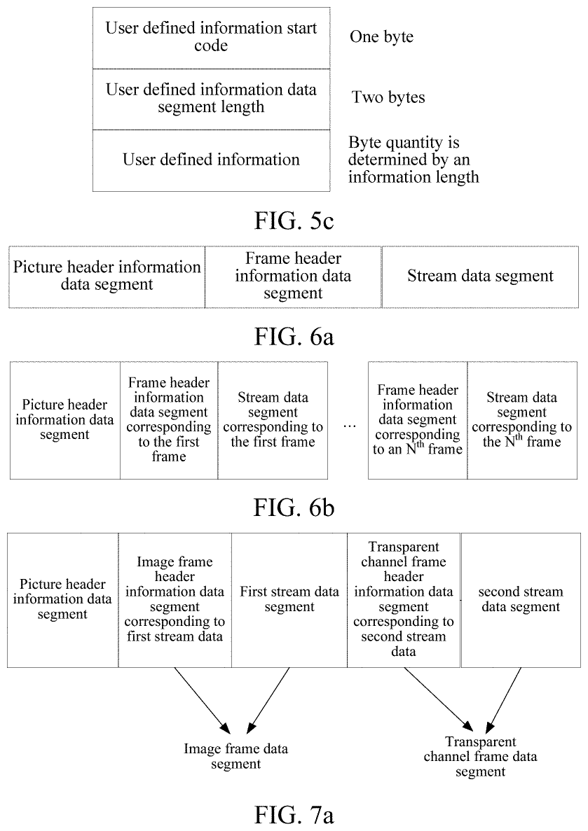

When first stream data and second stream data that are obtained by encoding one frame of image correspond to one piece of frame header information, for the frame header information, refer to an example diagram of frame header information shown in FIG. 8a. Refer to the following detailed descriptions.

The frame header information start code is a field used to indicate a start location of the frame header information, and is, for example, indicated by using one byte.

The frame header information data segment length indicates a length of the frame header information, and is, for example, indicated by using one byte. The information is optional information

The stream data segment length indicates a stream length of a stream data segment indicated by the frame header information. If the first stream data and the second stream data correspond to one piece of frame header information, the stream length herein is a sum of a length of the first stream data and a length of the second stream data. The information is optional information.

The delay time information exists only when the image file is an image file in a dynamic format, indicates a difference between a time at which an image corresponding to a current frame is displayed and a time at which an image corresponding to a next frame is displayed, and is, for example, indicated by using one byte.

It should be noted that, the foregoing is merely exemplary description, and a name of each piece of information included in the frame header information, a location of each piece of information in the frame header information, and a quantity of bits occupied for indicating each piece of information are not limited in this embodiment of this application.

When each of the first stream data and the second stream data corresponds to one piece of frame header information, the frame header information is divided into image frame header information and transparent channel frame header information. Also refer to FIG. 8b and FIG. 8c.

FIG. 8b is an example diagram of image frame header information according to an embodiment of this application. The image frame header information includes an image frame header information start code and delay time information used for indication if the image file is an image file in a dynamic format. In some embodiments of this application, the image frame header information further includes at least one of an image frame header information data segment length and a first stream data segment length of a first stream data segment indicated by the image frame header information. Further, in some embodiments of this application, the image frame header information further includes specific information for distinguishing from another frame of image, for example, encoding area information, transparency information, and a color table. This is not limited in this embodiment of this application.

The image frame header information start code is a field used to indicate a start location of the image frame header information, and is, for example, indicated by using one byte, for example, a bit string ‘0x000001BA’.

The image frame header information data segment length indicates a length of the image frame header information, and is, for example, indicated by using one byte. The information is optional information.

The first stream data segment length indicates a stream length of the first stream data segment indicated by the image frame header information. The information is optional information

The delay time information exists only when the image file is an image file in a dynamic format, indicates a difference between a time at which an image corresponding to a current frame is displayed and a time at which an image corresponding to a next frame is displayed, and is, for example, indicated by using one byte.

FIG. 8c is an example diagram of transparent channel frame header information according to an embodiment of this application. The transparent channel frame header information includes a transparent channel frame header information start code. In some embodiments of this application, the transparent channel frame header information further includes at least one of a transparent channel frame header information data segment length, a second stream data segment length of a second stream data segment indicated by the transparent channel frame header information, and delay time information used for indication if the image file is an image file in a dynamic format. Further, in some embodiments of this application, the transparent channel frame header information further includes specific information for distinguishing from another frame of image, for example, encoding area information, transparency information, and a color table. This is not limited in this embodiment of this application.

The transparent channel frame header information start code is a field used to indicate a start location of the transparent channel frame header information, and is, for example, indicated by using one byte, for example, a bit string ‘0x000001BB’.

The transparent channel frame header information data segment length indicates a length of the transparent channel frame header information, and is, for example, indicated by using one byte. The information is optional information.

The second stream data segment length indicates a stream length of the second stream data segment indicated by the transparent channel frame header information. The information is optional information.

The delay time information exists only when the image file is an image file in a dynamic format, indicates a difference between a time at which an image corresponding to a current frame is displayed and a time at which an image corresponding to a next frame is displayed, and is, for example, indicated by using one byte. The information is optional information. When the transparent channel frame header information includes no delay time information, refer to the delay time information in the image frame header information.

In this embodiment of this application, terms such as the image file, the image, the first stream data, the second stream data, the image header information, the frame header information, each piece of information included in the image header information, and each piece of information included in the frame header information may occur with other names. For example, the image file is described by using a “picture”, and as long as a function of each term is similar to that in this application, the term falls within the protection scope of the claims of this application and an equivalent technology thereof.

It should be further noted that, in this embodiment of this application, the RGBA data input before encoding may be obtained by decoding image files in various formats. A format of an image file may be any one of formats such as JPEG, BMP, PNG, APNG, and GIF. A format of the image file before encoding is not limited in this embodiment of this application.

It should be noted that, a form of each start code in this embodiment of this application is unique in entire compressed image data, to achieve a function of uniquely identifying each data segment. The image file in this embodiment of this application is used to indicate a complete image file or image file that may include one or more images, and an image is a frame of drawing. Video frame data in this embodiment of this application is stream data obtained after video encoding is performed on each frame of image in the image file. For example, the first stream data obtained after the RGB data is encoded may be considered as one piece of video frame data, and the second stream data obtained after the transparency data is encoded may also be considered as one piece of video frame data.

In this embodiment of this application, when the first image is the RGBA data, the encoding apparatus obtains the RGBA data corresponding to the first image in the image file, and separates the RGBA data to obtain the RGB data and the transparency data of the first image; encodes the RGB data of the first image according to the first video encoding mode, to generate the first stream data; encodes the transparency data of the first image according to the second video encoding mode, to generate the second stream data; generates the image header information and the frame header information that correspond to the image file including the first image; and finally writes the first stream data and the second stream data into the stream data segment, writes the image header information into the image header information data segment, and writes the frame header information into the frame header information data segment. In this way, through encoding by using the video encoding modes, a compression ratio of the image file can be improved, and a size of the image file can be reduced, so that a picture loading speed can be increased, and network transmission bandwidth and storage costs can be reduced. In addition, the RGB data and the transparency data in the image file are encoded respectively, to use the video encoding modes and reserve the transparency data in the image file, thereby ensuring quality of the image file.

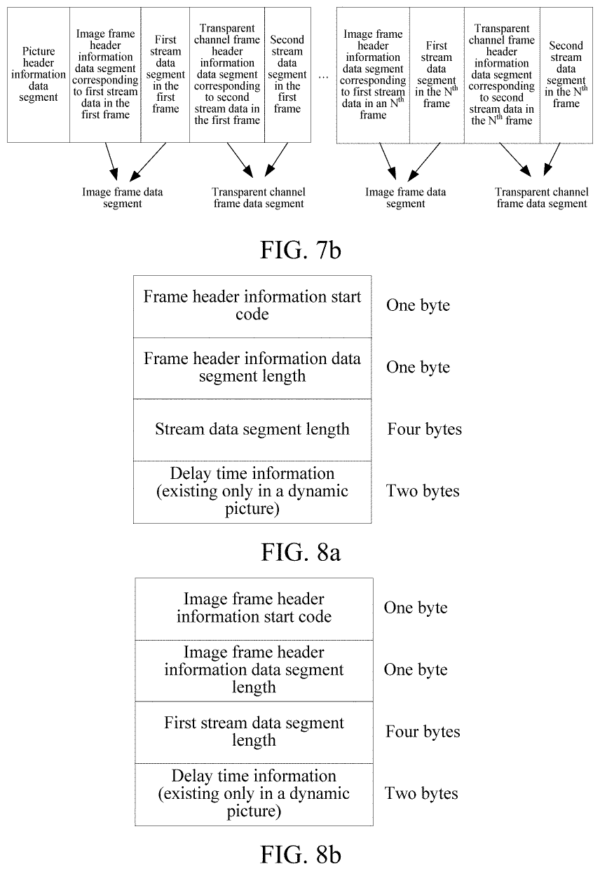

FIG. 9 is a schematic flowchart of an image file processing method according to an embodiment of this application. The method may be performed by the foregoing computing device. As shown in FIG. 9, it is assumed that the computing device is a terminal device, and the method in this embodiment of this application may include step 401 to step 404.

Step 401: Obtain, from a stream data segment of an image file, first stream data and second stream data that are generated from a first image in the image file.

Specifically, a decoding apparatus run on the terminal device obtains, from the stream data segment of the image file, the first stream data and the second stream data that are generated from the first image in the image file.

Step 402: Decode the first stream data according to a first video decoding mode, to generate RGB data of the first image.

Specifically, the decoding apparatus run on the terminal device decodes the first stream data according to the first video decoding mode. The first stream data and the second stream data are data that is generated from the first image and that is read from a stream data segment by the decoding apparatus by parsing the image file, and stream data related to the first image is obtained. The first image is an image included in the image file. When the image file includes transparency data, the decoding apparatus obtains the first stream data and the second stream data that indicate the first image. The first image may be a frame of image included in an image file in a static format; or the first image may be any one of a plurality of frames of images included in an image file in a dynamic format.

In some embodiments of this application, when the image file includes the RGB data and the transparency data, the image file has information used to indicate a stream data segment, and for an image file in a dynamic format, the image file has information used to indicate stream data segments corresponding to different frames of images, so that the decoding apparatus can obtain the first stream data generated from the RGB data of the first image and the second stream data generated from the transparency data of the first image.

Further, the decoding apparatus decodes the first stream data, to generate the RGB data of the first image.

Step 403: Decode the second stream data according to a second video decoding mode, to generate transparency data of the first image.

Specifically, the decoding apparatus decodes the second stream data according to the second video decoding mode, to generate the transparency data of the first image. The second stream data is also read in the same manner as that of reading the first stream data in step 402. Details are not described herein again.

For step 402 and step 403, the first video decoding mode or the second video decoding mode may be determined based on a video encoding mode used to generate the first stream data or generate the second stream data. For example, the first stream data is used as an example for description. If I-frame encoding is used for the first stream data, the first video decoding mode is that the RGB data can be generated according to current stream data; or if P-frame encoding is used for the first stream data, the first video decoding mode is that RGB data of a current frame is generated according to previous decoded data. For the second video decoding mode, refer to the descriptions of the first video decoding mode. Details are not described herein again.

It should be noted that, step 402 and step 403 are not limited to a particular order during execution.

Step 404: Generate, according to the RGB data and the transparency data of the first image, RGBA data corresponding to the first image.

Specifically, the decoding apparatus generates, according to the RGB data and the transparency data of the first image, the RGBA data corresponding to the first image. The RGBA data is a color space representing Red, Green, Blue, and Alpha. The RGB data and the transparency data can be combined into the RGBA data. In this way, corresponding RGBA data can be generated, by using a corresponding video decoding mode, from stream data obtained by performing encoding according to a video encoding mode, to use the video encoding/decoding modes and reserve the transparency data in the image file, thereby ensuring quality and a display effect of the image file.

For example, forms of the RGB data and the transparency data of the first image that are obtained through decoding by the decoding apparatus are as follows:

RGB RGB RGB RGB RGB RGB . . . RGB
A A A A A A . . . A

Therefore, the decoding apparatus combines the corresponding RGB data and transparency data, to obtain the RGBA data of the first image. A form of the RGBA data is as follows:

RGBA RGBA RGBA RGBA RGBA RGBA . . . RGBA

It should be noted that, the image file in this embodiment of this application includes the RGB data and the transparency data, and therefore the first stream data from which the RGB data can be generated and the second stream data from which the transparency data can be generated can be read by parsing the image file, and step 402 and step 403 are performed respectively. However, when the image file includes only the RGB data, the first stream data from which the RGB data can be generated can be read by parsing the image file, and step 402 is performed, to generate the RGB data, that is, decoding of the first stream data is completed.

In this embodiment of this application, the decoding apparatus decodes the first stream data according to the first video decoding mode, to generate the RGB data of the first image; decodes the second stream data according to the second video decoding mode, to generate the transparency data of the first image; and generates, according to the RGB data and the transparency data of the first image, the RGBA data corresponding to the first image. The first stream data and the second stream data in the image file are decoded respectively, to obtain the RGBA data, to use video encoding/decoding modes and reserve the transparency data in the image file, thereby ensuring quality of the image file.

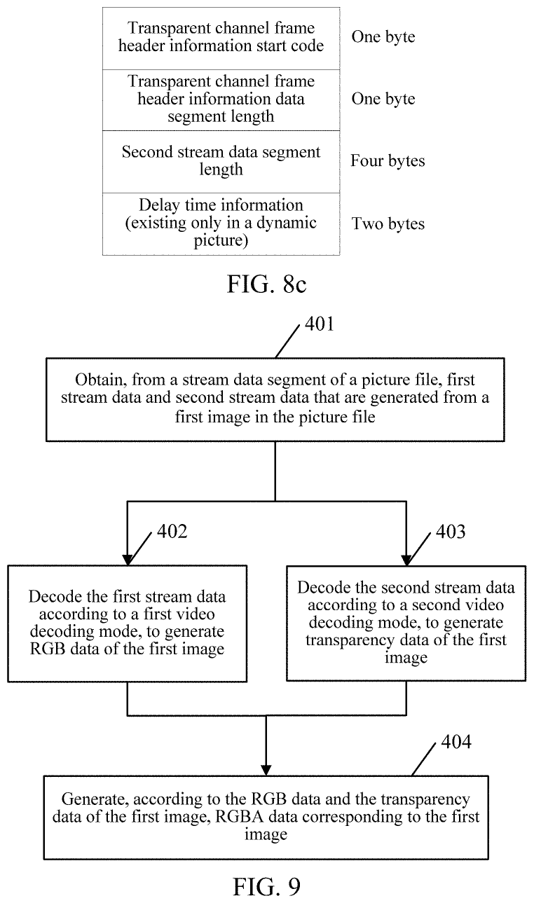

FIG. 10 is a schematic flowchart of another image file processing method according to an embodiment of this application. The method may be performed by the foregoing computing device. As shown in FIG. 10, it is assumed that the computing device is a terminal device, and the method in this embodiment of this application may include step 501 to step 507. This embodiment of this application is described by using an image file in a dynamic format as an example. Refer to the following detailed descriptions.

Step 501: Obtain first stream data and second stream data that are generated from a first image corresponding to a k^{th} frame in an image file in a dynamic format.

Specifically, a decoding apparatus run on the terminal device parses the image file in the dynamic format, to obtain, from a stream data segment of the image file, the first stream data and the second stream data that are generated from the first image corresponding to the k^{th} frame. When the image file includes transparency data, the decoding apparatus obtains the first stream data and the second stream data that indicate the first image. The image file in the dynamic format includes at least two frames of images, and the k^{th} frame may be any one of the at least two frames of images, where k is a positive integer greater than 0.

In some embodiments of this application, when the image file in the dynamic format includes RGB data and transparency data, the image file has information used to indicate stream data segments corresponding to different frames of images, so that the decoding apparatus can obtain the first stream data generated from the RGB data of the first image and the second stream data generated from the transparency data of the first image.

In some embodiments of this application, the decoding apparatus may perform decoding in an order of stream data corresponding to all frames in the image file in the dynamic format, that is, may first obtain and decode stream data corresponding to the first frame in the image file in the dynamic format. An order in which the decoding apparatus obtains the stream data, indicating all frames of images, of the image file in the dynamic format is not limited in this embodiment of this application.

In some embodiments of this application, the decoding apparatus may determine, by using image header information and frame header information of the image file, the stream data indicating an image corresponding to each frame. Refer to detailed descriptions of the image header information and the frame header information in a next embodiment.

Step 502: Decode the first stream data according to a first video decoding mode, to generate RGB data of the first image.

Specifically, the decoding apparatus decodes the first stream data according to the first video decoding mode, to generate the RGB data of the first image. In some embodiments of this application, the decoding apparatus decodes the first stream data according to the first video decoding mode, to generate first YUV data of the first image; and converts the first YUV data into the RGB data of the first image.

Step 503: Decode the second stream data according to a second video decoding mode, to generate transparency data of the first image.

Specifically, the decoding apparatus decodes the second stream data according to the second video decoding mode, to generate the transparency data of the first image. In some embodiments of this application, the decoding apparatus decodes the second stream data according to the second video decoding mode, to generate second YUV data of the first image; and converts the second YUV data into the transparency data of the first image. In some embodiments of this application, the decoding apparatus sets a Y component in the second YUV data as the transparency data of the first image, and discards a U component and a V component in the second YUV data.

It should be noted that, step 502 and step 503 are not limited to a particular order during execution.

Step 504: Generate, according to the RGB data and the transparency data of the first image, RGBA data corresponding to the first image.

Specifically, the decoding apparatus generates, according to the RGB data and the transparency data of the first image, the RGBA data corresponding to the first image. The RGBA data is a color space representing Red, Green, Blue, and Alpha. The RGB data and the transparency data can be combined into the RGBA data. In this way, corresponding RGBA data can be generated, by using a corresponding video decoding mode, from stream data obtained by performing encoding according to a video encoding mode, to use the video encoding/decoding modes and reserve the transparency data in the image file, thereby ensuring quality and a display effect of the image file.

For example, forms of the RGB data and the transparency data of the first image that are obtained through decoding by the decoding apparatus are as follows:

RGB RGB RGB RGB RGB RGB . . . RGB
A A A A A A . . . A

Therefore, the decoding apparatus combines the corresponding RGB data and transparency data, to obtain the RGBA data of the first image. A form of the RGBA data is as follows:

RGBA RGBA RGBA RGBA RGBA RGBA . . . RGBA

Step 505: Determine whether the k^{th} frame is the last frame in the image file in the dynamic format.

Specifically, the decoding apparatus determines whether the k^{th} frame is the last frame in the image file in the dynamic format. In some embodiments of this application, whether decoding of the image file is completed may be determined by detecting a quantity of frames included in the image header information. If the k^{th} frame is the last frame in the image file in the dynamic format, it indicates that decoding of the image file in the dynamic format is completed, and step 507 is performed. If the k^{th} frame is not the last frame in the image file in the dynamic format, step 506 is performed.

Step 506: Update k if the k^{th} frame is not the last frame in the image file in the dynamic format, and trigger execution of the operation of obtaining first stream data and second stream data of a first image corresponding to a k^{th} frame in an image file in a dynamic format.

Specifically, if determining that the k^{th} frame is not the last frame in the image file in the dynamic format, the decoding apparatus decodes stream data of an image corresponding to a next frame, that is, updates k by using a value of (k+1), and after updating k, triggers execution of the operation of obtaining first stream data and second stream data of a first image corresponding to a k^{th} frame in an image file in a dynamic format.

It may be understood that, an image obtained by using updated k and an image obtained before k is updated are not an image corresponding to the same frame. For ease of description, herein, the image corresponding to the k^{th} frame before k is updated is set as the first image, and the image corresponding to the k^{th} frame after k is updated is set as a second image, to facilitate distinguishing.

When step 502 to step 504 are performed for the second image, in some embodiments of this application, stream data indicating the second image is third stream data and fourth stream data; the third stream data is decoded according to a third video decoding mode, to generate RGB data of the second image; the fourth stream data is decoded according to a fourth video decoding mode, to generate transparency data of the second image, where the third stream data is generated according to the RGB data of the second image, and the fourth stream data is generated according to the transparency data of the second image; and RGBA data corresponding to the second image is generated according to the RGB data and the transparency data of the second image.

For step 502 and step 503, the first video decoding mode, the second video decoding mode, the third video decoding mode, or the fourth video decoding mode above is determined based on a video encoding mode used to generate stream data. For example, the first stream data is used as an example for description. If I-frame encoding is used for the first stream data, the first video decoding mode is that the RGB data can be generated according to current stream data; or if P-frame encoding is used for the first stream data, the first video decoding mode is that RGB data of a current frame is generated according to previous decoded data. For another video decoding mode, refer to the descriptions of the first video decoding mode. Details are not described herein again.

It should be further noted that, the image file in the dynamic format includes a plurality of stream data segments. In some embodiments of this application, one frame of image corresponds to one stream data segment. Alternatively, in some other embodiments of this application, one piece of stream data corresponds to one stream data segment. Therefore, the stream data segment from which the first stream data and the second stream data are read is different from the stream data segment from which the third stream data and the fourth stream data are read.

Step 507: If the k^{th} frame is the last frame in the image file in the dynamic format, complete decoding of the image file in the dynamic format.

Specifically, if the decoding apparatus determines that the k^{th} frame is the last frame in the image file in the dynamic format, it indicates that decoding of the image file in the dynamic format is completed.

In some embodiments of this application, the decoding apparatus may parse the image file, to obtain image header information and frame header information of the image file in the dynamic format. In this way, whether the image file includes the transparency data may be determined by using the image header information, and then whether to obtain only the first stream data generated from the RGB data or obtain the first stream data generated from the RGB data and the second stream data generated from the transparency data in a decoding process may be determined.

It should be noted that, the image corresponding to each frame in the image file in the dynamic format in this embodiment of this application is RGBA data including RGB data and transparency data. However, when the image corresponding to each frame in the image file in the dynamic format includes only RGB data, stream data indicating each frame of image is only the first stream data, and therefore the decoding apparatus may perform step 502 for first stream data indicating each frame of image, to generate the RGB data. In this way, the stream data including only the RGB data can still be decoded by using a video decoding mode.

In this embodiment of this application, when determining that the image file in the dynamic format includes the RGB data and the transparency data, the decoding apparatus decodes, according to the first video decoding mode, the first stream data indicating each frame of image, to generate the RGB data of the first image; decodes, according to the second video decoding mode, the second stream data indicating each frame of image, to generate the transparency data of the first image; and generates, according to the RGB data and the transparency data of the first image, the RGBA data corresponding to the first image. The first stream data and the second stream data in the image file are decoded respectively, to obtain the RGBA data, to use video encoding/decoding modes and reserve the transparency data in the image file, thereby ensuring quality of the image file.

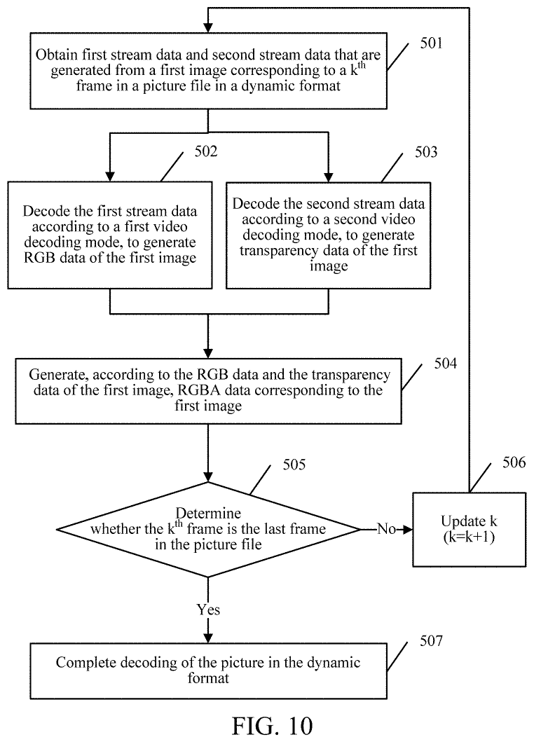

FIG. 11 is a schematic flowchart of another image file processing method according to an embodiment of this application. The method may be performed by the foregoing computing device. As shown in FIG. 11, it is assumed that the computing device is a terminal device, and the method in this embodiment of this application may include step 601 to step 606.

Step 601: Parse an image file, to obtain image header information and frame header information of the image file.

Specifically, a decoding apparatus run on the terminal device parses the image file, to obtain the image header information and the frame header information of the image file. The image header information includes image feature information indicating whether there is transparency data in the image file, and whether the transparency data is included may be determined, to determine how to obtain stream data and whether the obtained stream data includes second stream data generated from the transparency data. The frame header information is used to indicate a stream data segment of the image file, and the stream data segment from which the stream data can be obtained may be determined by using the frame header information, thereby decoding the stream data. For example, the frame header information includes a frame header information start code, and the stream data segment can be determined by identifying the frame header information start code.

In some embodiments of this application, the parsing, by the decoding apparatus, the image file, to obtain the image header information of the image file may be specifically: reading the image header information of the image file from an image header information data segment of the image file.

In some embodiments of this application, the parsing, by the decoding apparatus, the image file, to obtain the frame header information of the image file may be specifically: reading the frame header information of the image file from a frame header information data segment of the image file.

It should be noted that, for the image header information and the frame header information in this embodiment of this application, refer to the exemplary descriptions of FIG. 5a, FIG. 5b, FIG. 5c, FIG. 6a, FIG. 6b, FIG. 7a, FIG. 7b, FIG. 8a, FIG. 8b, and FIG. 8c. Details are not described herein again.

Step 602: Read stream data from a stream data segment indicated by the frame header information of the image file.

Specifically, if determining, by using the image feature information, that the image file includes the transparency data, the decoding apparatus reads the stream data from the stream data segment indicated by the frame header information of the image file. The stream data includes first stream data and second stream data.

In some embodiments of this application, one frame of image in the image file corresponds to one piece of frame header information, that is, the frame header information may be used to indicate the stream data segment including the first stream data and the second stream data. Specifically, when the image file is the image file in the static format, the image file in the static format includes one frame of image, namely, the first image, and therefore, the image file in the static format includes one piece of frame header information. When the image file is the image file in the dynamic format, the image file in the dynamic format usually includes at least two frames of images, and each of the at least two frames of images has one piece of frame header information. If determining that the image file includes the transparency data, the decoding apparatus reads the first stream data and the second stream data according to the stream data segment indicated by the frame header information.

In some other embodiments of this application, one piece of stream data in one frame of image in the image file corresponds to one piece of frame header information, that is, a stream data segment indicated by one piece of frame header information includes one piece of stream data. Specifically, in a case of the image file in the static format, the image file in the static format includes one frame of image, namely, the first image, and the first image including the transparency data corresponds to two pieces of stream data that are respectively the first stream data and the second stream data. Therefore, the first stream data in the image file in the static format corresponds to one piece of frame header information, and the second stream data corresponds to the other piece of frame header information. In a case of the image file in the dynamic format, the image file in the dynamic format includes at least two frames of images, each frame of image including transparency data corresponds to two pieces of stream data that are respectively the first stream data and the second stream data, and one piece of frame header information is added to each of the first stream data and the second stream data of each frame of image. Therefore, if determining that the image file includes the transparency data, the decoding apparatus respectively obtains the first stream data and the second stream data according to two stream data segments respectively indicated by two pieces of frame header information.

It should be noted that, when one piece of stream data in one frame of image in the image file corresponds to one piece of frame header information, an encoding apparatus may arrange, in a preset order, a frame header information data segment and a first stream data segment that correspond to the first stream data, and a frame header information data segment and a second stream data segment that correspond to the second stream data, and the decoding apparatus may determine the arrangement order of the encoding apparatus. For example, a first stream data segment, a second stream data segment, and frame header information data segments corresponding to various pieces of stream data of one frame of image may be arranged according to the frame header information data segment and the first stream data segment that correspond to the first stream data, and the frame header information data segment and the second stream data segment that correspond to the second stream data. In this way, in a decoding process, the decoding apparatus can determine, in stream data segments indicated by two pieces of frame header information and two frame headers that indicate the frame of image, a stream data segment from which the first stream data can be obtained, and a stream data segment from which the second stream data can be obtained. It may be understood that, herein, the first stream data is stream data generated from the RGB data, and the second stream data is stream data generated from the transparency data.

Step 603: Decode the first stream data according to a first video decoding mode, to generate RGB data of the first image.

Step 604: Decode the second stream data according to a second video decoding mode, to generate transparency data of the first image.

Step 605: Generate, according to the RGB data and the transparency data of the first image, RGBA data corresponding to the first image.

For step 603 to step 605, refer to detailed descriptions of corresponding steps in the embodiments in FIG. 9 and FIG. 10. Details are not described herein again.

In this embodiment of this application, when the image file includes the RGB data and the transparency data, the decoding apparatus parses the image file, to obtain the image header information and the frame header information of the image file, and reads the stream data in the stream data segment indicated by the frame header information of the image file; decodes, according to the first video decoding mode, the first stream data indicating each frame of image, to generate the RGB data of the first image; decodes, according to the second video decoding mode, the second stream data indicating each frame of image, to generate the transparency data of the first image; and generates, according to the RGB data and the transparency data of the first image, the RGBA data corresponding to the first image. The first stream data and the second stream data in the image file are decoded respectively, to obtain the RGBA data, to use video encoding/decoding modes and reserve the transparency data in the image file, thereby ensuring quality of the image file.

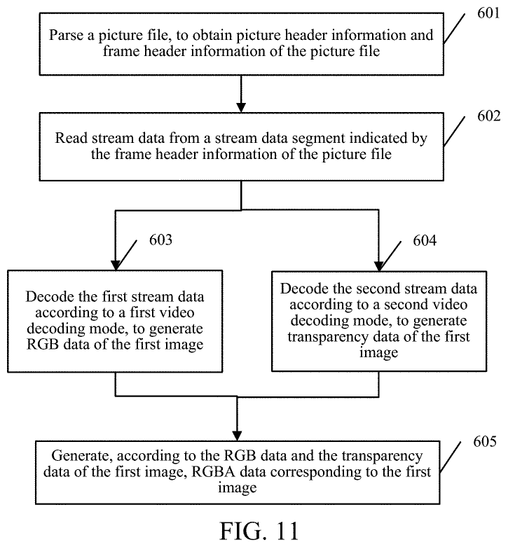

FIG. 12 is a schematic flowchart of another image file processing method according to an embodiment of this application. The method may be performed by the foregoing computing device. As shown in FIG. 12, it is assumed that the computing device is a terminal device, and the method in this embodiment of this application may include step 701 to step 705.

Step 701: Generate image header information and frame header information that correspond to an image file.

Specifically, an image file processing apparatus run on the terminal device generates the image header information and the frame header information that correspond to the image file. The image file may be an image file in a static format, that is, includes only the first image; or the image file is an image file in a dynamic format, that is, includes the first image and another image. Regardless of whether the image file is the image file in the static format or the image file in the dynamic format, the image file processing apparatus needs to generate the image header information corresponding to the image file. The image header information includes image feature information indicating whether there is transparency data in the image file, so that a decoding apparatus determines, by using the image feature information, whether the image file includes the transparency data, to determine how to obtain stream data and whether the obtained stream data includes the second stream data generated from the transparency data.

Further, the frame header information is used to indicate a stream data segment of the image file, so that the decoding apparatus determines, by using the frame header information, the stream data segment from which the stream data can be obtained, thereby decoding the stream data. For example, the frame header information includes a frame header information start code, and the stream data segment can be determined by identifying the frame header information start code.

Step 702: Write the image header information into an image header information data segment of the image file.

Specifically, the image file processing apparatus writes the image header information into the image header information data segment of the image file.

Step 703: Write the frame header information into a frame header information data segment of the image file.

Specifically, the image file processing apparatus writes the frame header information into the frame header information data segment of the image file.

Step 704: Encode, according to a first video encoding mode, RGB data included in RGBA data corresponding to the first image, to generate first stream data, and encode, according to a second video encoding mode, transparency data included in the RGBA data corresponding to the first image, to generate second stream data, if it is determined, according to image feature information included in the image header information, that the image file includes transparency data.

Specifically, if determining that the first image in the image file includes the transparency data, the image file processing apparatus encodes, according to the first video encoding mode, the RGB data included in the RGBA data corresponding to the first image, to generate the first stream data, and encodes, according to the second video encoding mode, the transparency data included in the RGBA data corresponding to the first image, to generate the second stream data.

In some embodiments of this application, after obtaining the RGBA data corresponding to the first image in the image file, the image file processing apparatus separates the RGBA data to obtain the RGB data and the transparency data of the first image.

The RGB data is color data included in the RGBA data, and the transparency data is transparency data included in the RGBA data. Further, the RGB data and the transparency data are encoded respectively. For a specific encoding process, refer to detailed descriptions of the embodiments shown in FIG. 1 to FIG. 4d. Details are not described herein again.

Step 705: Write the first stream data and the second stream data into a stream data segment indicated by frame header information corresponding to the first image.

Specifically, the image file processing apparatus writes the first stream data and the second stream data into the stream data segment indicated by the frame header information corresponding to the first image.

It should be noted that, for the image header information and the frame header information in this embodiment of this application, refer to the exemplary descriptions of FIG. 5a, FIG. 5b, FIG. 5c, FIG. 6a, FIG. 6b, FIG. 7a, FIG. 7b, FIG. 8a, FIG. 8b, and FIG. 8c. Details are not described herein again.

It should be further noted that, in this embodiment of this application, the RGBA data input before encoding may be obtained by decoding image files in various formats. A format of an image file may be any one of formats such as JPEG, BMP, PNG, APNG, and GIF. A format of the image file before encoding is not limited in this embodiment of this application.

In this embodiment of this application, the image file processing apparatus generates the image header information and the frame header information that correspond to the image file. The decoding apparatus can determine, by using the image feature information that is included in the image header information and that indicates whether there is transparency data in the image file, how to obtain stream data and whether the obtained stream data includes the second stream data generated from the transparency data. The decoding apparatus can obtain the stream data in the stream data segment by using the stream data segment of the image file that is indicated by the frame header information, thereby decoding the stream data.

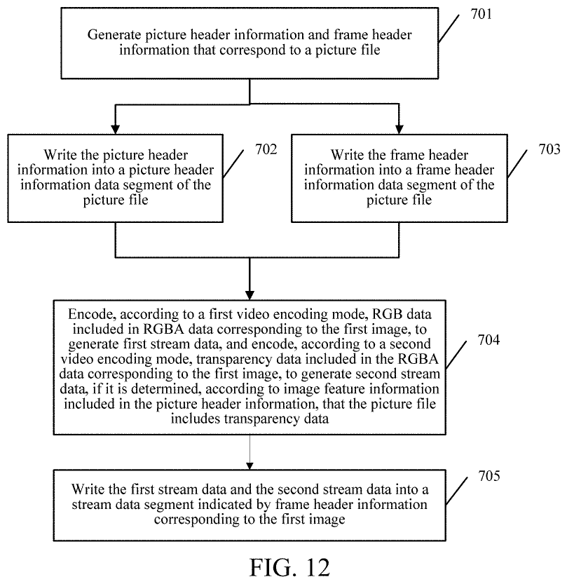

FIG. 13 is a schematic flowchart of another image file processing method according to an embodiment of this application. The method may be performed by the foregoing computing device. As shown in FIG. 13, it is assumed that the computing device is a terminal device, and the method in this embodiment of this application may include step 801 to step 803.

Step 801: Parse an image file, to obtain image header information and frame header information of the image file.

Specifically, an image file processing apparatus run on the terminal device parses the image file, to obtain the image header information and the frame header information of the image file. The image header information includes image feature information indicating whether there is transparency data in the image file, and whether the image file includes the transparency data may be determined, to determine how to obtain stream data and whether the obtained stream data includes second stream data generated from the transparency data. The frame header information is used to indicate a stream data segment of the image file, and the stream data segment from which the stream data can be obtained may be determined by using the frame header information, thereby decoding the stream data. For example, the frame header information includes a frame header information start code, and the stream data segment can be determined by identifying the frame header information start code.

In some embodiments of this application, the parsing, by the image file processing apparatus, the image file, to obtain the image header information of the image file may be specifically: reading the image header information of the image file from an image header information data segment of the image file.

In some embodiments of this application, the parsing, by the image file processing apparatus, the image file, to obtain the frame header information of the image file may be specifically: reading the frame header information of the image file from a frame header information data segment of the image file.

It should be noted that, for the image header information and the frame header information in this embodiment of this application, refer to the exemplary descriptions of FIG. 5a, FIG. 5b, FIG. 5c, FIG. 6a, FIG. 6b, FIG. 7a, FIG. 7b, FIG. 8a, FIG. 8b, and FIG. 8c. Details are not described herein again.

Step 802: Read, if it is determined, by using image feature information, that the image file includes transparency data, stream data from a stream data segment indicated by the frame header information of the image file, where the stream data includes first stream data and second stream data.

Specifically, if determining, by using the image feature information, that the image file includes the transparency data, the image file processing apparatus reads the stream data from the stream data segment indicated by the frame header information of the image file. The stream data includes the first stream data and the second stream data.

In some embodiments of this application, one frame of image in the image file corresponds to one piece of frame header information, that is, the frame header information may be used to indicate the stream data segment including the first stream data and the second stream data. Specifically, when the image file is the image file in the static format, the image file in the static format includes one frame of image, namely, the first image, and therefore, the image file in the static format includes one piece of frame header information. When the image file is the image file in the dynamic format, the image file in the dynamic format usually includes at least two frames of images, and one piece of frame header information is added to each of the at least two frames of images. If determining that the image file includes the transparency data, the image file processing apparatus reads the first stream data and the second stream data according to the stream data segment indicated by the frame header information.

In some other embodiments of this application, one piece of stream data in one frame of image in the image file corresponds to one piece of frame header information, that is, a stream data segment indicated by one piece of frame header information includes one piece of stream data. Specifically, in a case of the image file in the static format, the image file in the static format includes one frame of image, namely, the first image, and the first image including the transparency data corresponds to two pieces of stream data that are respectively the first stream data and the second stream data. Therefore, the first stream data in the image file in the static format corresponds to one piece of frame header information, and the second stream data corresponds to the other piece of frame header information. In a case of the image file in the dynamic format, the image file in the dynamic format includes at least two frames of images, each frame of image including transparency data corresponds to two pieces of stream data that are respectively the first stream data and the second stream data, and one piece of frame header information is added to each of the first stream data and the second stream data of each frame of image. Therefore, if determining that the image file includes the transparency data, the image file processing apparatus respectively obtains the first stream data and the second stream data according to two stream data segments respectively indicated by two pieces of frame header information.

It should be noted that, when one piece of stream data in one frame of image in the image file corresponds to one piece of frame header information, an encoding apparatus may arrange, in a preset order, a frame header information data segment and a first stream data segment that correspond to the first stream data, and a frame header information data segment and a second stream data segment that correspond to the second stream data, and the image file processing apparatus may determine the arrangement order of the encoding apparatus. For example, a first stream data segment, a second stream data segment, and frame header information data segments corresponding to various pieces of stream data of one frame of image may be arranged according to the frame header information data segment and the first stream data segment that correspond to the first stream data, and the frame header information data segment and the second stream data segment that correspond to the second stream data. In this way, in a decoding process, the image file processing apparatus can determine, in stream data segments indicated by two pieces of frame header information and two frame headers that indicate the frame of image, a stream data segment from which the first stream data can be obtained, and a stream data segment from which the second stream data can be obtained. It may be understood that, herein, the first stream data is stream data generated from the RGB data, and the second stream data is stream data generated from the transparency data.

Step 803: Decode the first stream data and the second stream data respectively.

Specifically, after the image file processing apparatus obtains the first stream data and the second stream data from the stream data segment, the image file processing apparatus decodes the first stream data and the second stream data respectively.

It should be noted that, the image file processing apparatus may decode the first stream data and the second stream data with reference to an execution process of the decoding apparatus in the embodiments shown in FIG. 9 to FIG. 11. Details are not described herein again.

In this embodiment of this application, the image file processing apparatus may parse the image file, to obtain the image header information and the frame header information, and can determine, by using the image feature information that is included in the image header information and that indicates whether there is transparency data in the image file, how to obtain the stream data and whether the obtained stream data includes the second stream data generated from the transparency data; and obtains the stream data in the stream data segment by using the stream data segment of the image file that is indicated by the frame header information, thereby decoding the stream data.

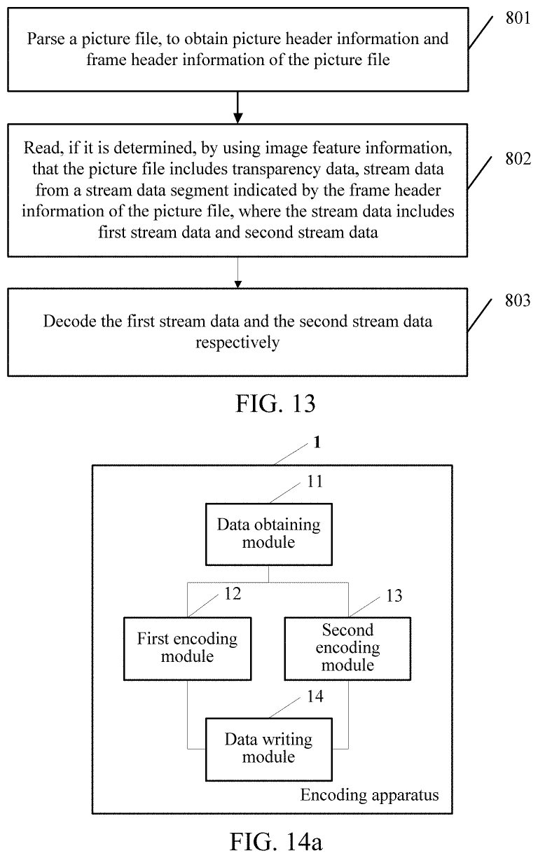

FIG. 14a is a schematic structural diagram of an encoding apparatus according to an embodiment of this application. As shown in FIG. 14a, the encoding apparatus 1 in this embodiment of this application may include a data obtaining module 11, a first encoding module 12, a second encoding module 13, and a data writing module 14.

The data obtaining module 11 is configured to: obtain RGBA data corresponding to a first image in an image file, and separate the RGBA data to obtain RGB data and transparency data of the first image, where the RGB data is color data included in the RGBA data, and the transparency data is transparency data included in the RGBA data.

The first encoding module 12 is configured to encode the RGB data of the first image according to a first video encoding mode, to generate first stream data.

The second encoding module 13 is configured to encode the transparency data of the first image according to a second video encoding mode, to generate second stream data.

The data writing module 14 is configured to write the first stream data and the second stream data into a stream data segment of the image file, where the first image is an image included in the image file.

In some embodiments of this application, as shown in FIG. 14b, the first encoding module 12 includes a first data conversion unit 121 and a first stream generation unit 122.

The first data conversion unit 121 is configured to convert the RGB data of the first image into first YUV data.

The first stream generation unit 122 is configured to encode the first YUV data according to the first video encoding mode, to generate the first stream data.

In some embodiments of this application, as shown in FIG. 14c, the second encoding module 13 includes a second data conversion unit 131 and a second stream generation unit 132.

The second data conversion unit 131 is configured to convert the transparency data of the first image into second YUV data.

The second stream generation unit 132 is configured to encode the second YUV data according to the second video encoding mode, to generate the second stream data.

In some embodiments of this application, the second data conversion unit 131 is configured to: set the transparency data of the first image as a Y component in the second YUV data, and skip setting a U component and a V component in the second YUV data. Alternatively, the second data conversion unit 131 is configured to: set the transparency data of the first image as a Y component in the second YUV data, and set a U component and a V component in the second YUV data as preset data.

In some embodiments of this application, the data obtaining module 11 is configured to: determine, if the image file is an image file in a dynamic format and the first image is an image corresponding to a k^{th} frame in the image file, whether the k^{th} frame is the last frame in the image file, where k is a positive integer greater than 0; and obtain, if the k^{th} frame is not the last frame in the image file, RGBA data corresponding to a second image corresponding to a (k+1)^{th} frame in the image file, and separate the RGBA data corresponding to the second image to obtain RGB data and transparency data of the second image.

The first encoding module 12 is further configured to encode the RGB data of the second image according to a third video encoding mode, to generate third stream data.

The second encoding module 13 is further configured to encode the transparency data of the second image according to a fourth video encoding mode, to generate fourth stream data.

The data writing module 14 is further configured to write the third stream data and the fourth stream data into a stream data segment of the image file.

In some embodiments of this application, as shown in FIG. 14d, the encoding apparatus 1 further includes:

an information generation module 15, configured to generate image header information and frame header information that correspond to the image file, where the image header information includes image feature information indicating whether there is transparency data in the image file, and the frame header information is used to indicate the stream data segment of the image file.

In some embodiments of this application, the data writing module 13 is further configured to write the image header information generated by the information generation module 15 into an image header information data segment of the image file.

In some embodiments of this application, the data writing module 13 is further configured to write the frame header information generated by the information generation module 15 into a frame header information data segment of the image file.

It should be noted that, modules and units executed by and a beneficial effect brought by the encoding apparatus 1 described in this embodiment of this application may be specifically implemented according to the methods in the method embodiments shown in FIG. 1c to FIG. 8c. Details are not described herein again.

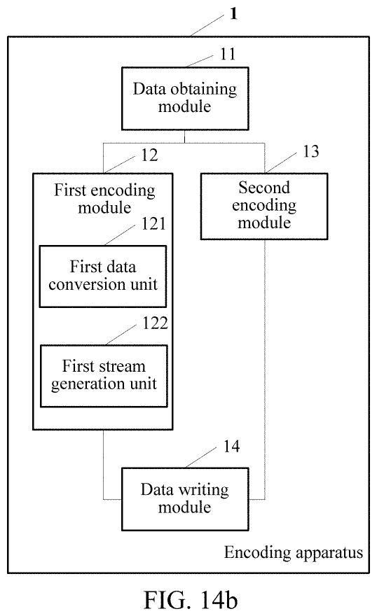

FIG. 15 is a schematic structural diagram of another encoding apparatus according to an embodiment of this application. As shown in FIG. 15, the encoding apparatus 1000 may include at least one processor 1001, for example, a CPU, at least one network interface 1004, a memory 1005, and at least one communications bus 1002. The network interface 1004 may include a standard wired interface or wireless interface (for example, a Wi-Fi interface). The memory 1005 may be a high-speed random access memory (RAM), or may be a non-volatile memory, for example, at least one magnetic disk memory. In some embodiments of this application, the memory 1005 may alternatively be at least one storage apparatus away from the processor 1001. The communications bus 1002 is configured to implement connection and communication between the components. In some embodiments of this application, the encoding apparatus 1000 includes a user interface 1003. The user interface 1003 may include a display screen (Display) 10031 and a keyboard 10032. As shown in FIG. 15, the memory 1005 as a computer-readable storage medium may include an operating system 10051, a network communications module 10052, a user interface module 10053, and a machine-readable instruction 10054. The machine-readable instruction 10054 includes an encoding application program 10055.

In the encoding apparatus 1000 shown in FIG. 15, the processor 1001 may be configured to: invoke the encoding application program 10055 stored in the memory 1005, and specifically perform the following operations:

obtaining RGBA data corresponding to a first image in an image file, and separating the RGBA data to obtain RGB data and transparency data of the first image, where the RGB data is color data included in the RGBA data, and the transparency data is transparency data included in the RGBA data;

encoding the RGB data of the first image according to a first video encoding mode, to generate first stream data;

encoding the transparency data of the first image according to a second video encoding mode, to generate second stream data; and

writing the first stream data and the second stream data into a stream data segment of the image file.

In an embodiment, when encoding the RGB data of the first image according to the first video encoding mode, to generate the first stream data, the processor 1001 specifically performs the following operations:

converting the RGB data of the first image into first YUV data; and encoding the first YUV data according to the first video encoding mode, to generate the first stream data.

In an embodiment, when encoding the transparency data of the first image according to the second video encoding mode, to generate the second stream data, the processor 1001 specifically performs the following operations:

converting the transparency data of the first image into second YUV data; and

encoding the second YUV data according to the second video encoding mode, to generate the second stream data.

In an embodiment, when converting the transparency data of the first image into the second YUV data, the processor 1001 specifically performs the following operations:

setting the transparency data of the first image as a Y component in the second YUV data, and skipping setting a U component and a V component in the second YUV data;

or setting the transparency data of the first image as a Y component in the second YUV data, and setting a U component and a V component in the second YUV data as preset data.

In an embodiment, the processor 1001 further performs the following steps:

determining, if the image file is an image file in a dynamic format and the first image is an image corresponding to a k^{th} frame in the image file, whether the k^{th} frame is the last frame in the image file, where k is a positive integer greater than 0; and obtaining, if the k^{th} frame is not the last frame in the image file, RGBA data corresponding to a second image corresponding to a (k+1)^{th} frame in the image file, and separating the RGBA data corresponding to the second image to obtain RGB data and transparency data of the second image;

encoding the RGB data of the second image according to a third video encoding mode, to generate third stream data;

encoding the transparency data of the second image according to a fourth video encoding mode, to generate fourth stream data; and

writing the third stream data and the fourth stream data into a stream data segment of the image file.

In an embodiment, the processor 1001 further performs the following step:

generating image header information and frame header information that correspond to the image file, where the image header information includes image feature information indicating whether there is transparency data in the image file, and the frame header information is used to indicate the stream data segment of the image file.

In an embodiment, the processor 1001 further performs the following step:

writing the image header information into an image header information data segment of the image file.

In an embodiment, the processor 1001 further performs the following step:

writing the frame header information into a frame header information data segment of the image file.

It should be noted that, steps performed by and a beneficial effect brought by the processor 1001 described in this embodiment of this application may be specifically implemented according to the methods in the method embodiments shown in FIG. 1c to FIG. 8c. Details are not described herein again.

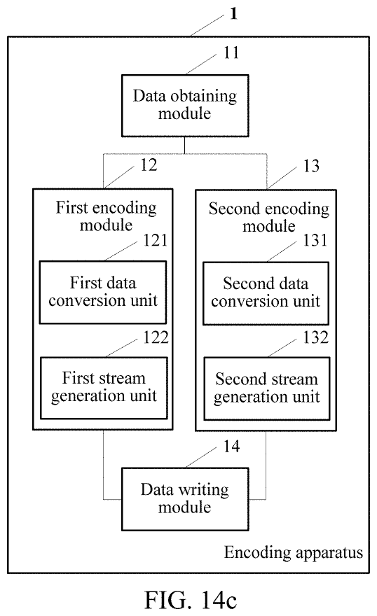

FIG. 16a is a schematic structural diagram of a decoding apparatus according to an embodiment of this application. As shown in FIG. 16a, the decoding apparatus 2 in this embodiment of this application may include a first data obtaining module 26, a first decoding module 21, a second decoding module 22, and a data generation module 23. In this embodiment of this application, first stream data and second stream data are data that is generated from the first image and that is read from a stream data segment of an image file.

The first data obtaining module 26 is configured to obtain, from a stream data segment of an image file, first stream data and second stream data that are generated from a first image in the image file.

The first decoding module 21 is configured to decode the first stream data according to a first video decoding mode, to generate RGB data of the first image.

The second decoding module 22 is configured to decode the second stream data according to a second video decoding mode, to generate transparency data of the first image.

The data generation module 23 is configured to generate, according to the RGB data and the transparency data of the first image, RGBA data corresponding to the first image.

In some embodiments of this application, as shown in FIG. 16b, the first decoding module 21 includes a first data generation unit 211 and a first data conversion unit 212.

The first data generation unit 211 is configured to decode the first stream data according to the first video decoding mode, to generate first YUV data of the first image.

The first data conversion unit 212 is configured to convert the first YUV data into the RGB data of the first image.

In some embodiments of this application, as shown in FIG. 16c, the second decoding module 22 includes a second data generation unit 221 and a second data conversion unit 222.

The second data generation unit 221 is configured to decode the second stream data according to the second video decoding mode, to generate second YUV data of the first image.

The second data conversion unit 222 is configured to convert the second YUV data into the transparency data of the first image.

In some embodiments of this application, the second data conversion unit 222 is specifically configured to: set a Y component in the second YUV data as the transparency data of the first image, and discard a U component and a V component in the second YUV data.

In some embodiments of this application, as shown in FIG. 16d, the decoding apparatus 2 further includes:

a second data obtaining module 24, configured to: determine, if the image file is an image file in a dynamic format and the first image is an image corresponding to a k^{th} frame in the image file in the dynamic format, whether the k^{th} frame is the last frame in the image file, where k is a positive integer greater than 0; and obtain, if the k^{th} frame is not the last frame in the image file, from the stream data segment of the image file, third stream data and fourth stream data that are generated from a second image corresponding to a (k+1)^{th} frame in the image file.

The first decoding module 21 is further configured to decode the third stream data according to a third video decoding mode, to generate RGB data of the second image.

The second decoding module 22 is further configured to decode the fourth stream data according to a fourth video decoding mode, to generate transparency data of the second image.

The data generation module 23 is further configured to generate, according to the RGB data and the transparency data of the second image, RGBA data corresponding to the second image.

In some embodiments of this application, as shown in FIG. 16e, the decoding apparatus 2 further includes a file parsing module 25.

The file parsing module 25 is configured to parse the image file, to obtain image header information and frame header information of the image file, where the image header information includes image feature information indicating whether there is transparency data in the image file, and the frame header information is used to indicate the stream data segment of the image file.

In some embodiments of this application, the file parsing module 25 is specifically configured to read the image header information of the image file from an image header information data segment of the image file.

In some embodiments of this application, the file parsing module 25 is specifically configured to read the frame header information of the image file from a frame header information data segment of the image file.

In some embodiments of this application, the first data obtaining module 26 is configured to read, if it is determined, by using the image feature information, that the image file includes transparency data, stream data from a stream data segment indicated by the frame header information of the image file, where the stream data includes first stream data and second stream data.

It should be noted that, modules and units executed by and a beneficial effect brought by the decoding apparatus 2 described in this embodiment of this application may be specifically implemented according to the methods in the method embodiments shown in FIG. 9 to FIG. 11. Details are not described herein again.

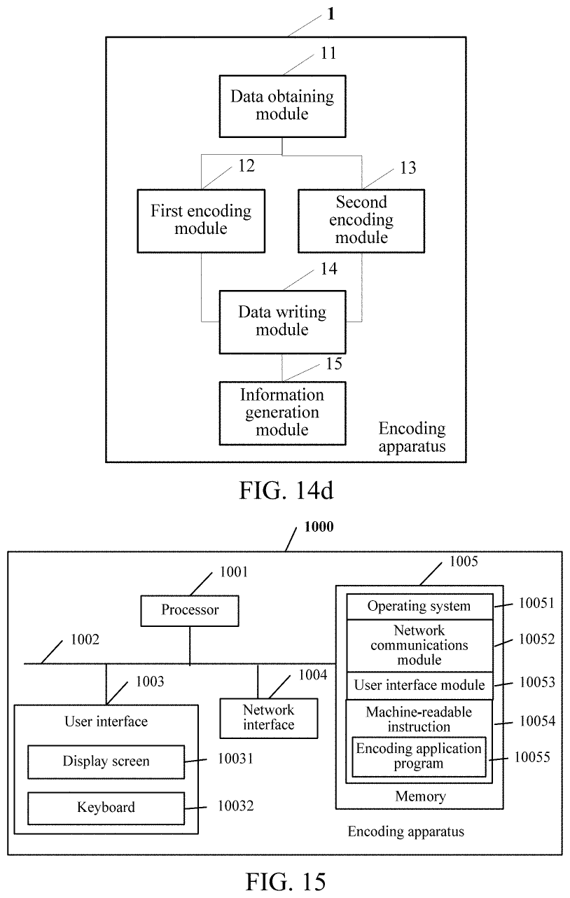

FIG. 17 is a schematic structural diagram of another decoding apparatus according to an embodiment of this application. As shown in FIG. 17, the decoding apparatus 2000 may include at least one processor 2001, for example, a CPU, at least one network interface 2004, a memory 2005, and at least one communications bus 2002. The network interface 2004 may include a standard wired interface or wireless interface (for example, a Wi-Fi interface). The memory 2005 may be a high-speed RAM, or may be a non-volatile memory, for example, at least one magnetic disk memory. The memory 2005 may alternatively be at least one storage apparatus away from the processor 2001. The communications bus 2002 is configured to implement connection and communication between the components. In some embodiments of this application, the decoding apparatus 2000 includes a user interface 2003. The user interface 2003 may include a display screen (Display) 20031 and a keyboard 20032. As shown in FIG. 17, the memory 2005 as a computer-readable storage medium may include an operating system 20051, a network communications module 20052, a user interface module 20053, and a machine-readable instruction 20054. The machine-readable instruction 20054 includes a decoding application program 20055.

In the decoding apparatus 2000 shown in FIG. 17, the processor 2001 may be configured to: invoke the decoding application program 20055 in the memory 2005, and specifically perform the following operations:

obtaining, from a stream data segment of an image file, first stream data and second stream data that are generated from a first image in the image file;

decoding the first stream data according to a first video decoding mode, to generate RGB data of the first image;

decoding the second stream data according to a second video decoding mode, to generate transparency data of the first image; and

generating, according to the RGB data and the transparency data of the first image, RGBA data corresponding to the first image, where the first stream data and the second stream data are data that is generated from the first image and that is read from a stream data segment of the image file.

In an embodiment, when decoding the first stream data according to the first video decoding mode, to generate the RGB data of the first image, the processor 2001 specifically performs the following operations:

decoding the first stream data according to the first video decoding mode, to generate first YUV data of the first image; and converting the first YUV data into the RGB data of the first image.

In an embodiment, when decoding the second stream data according to the second video decoding mode, to generate the transparency data of the first image, the processor 2001 specifically performs the following operations:

decoding the second stream data according to the second video decoding mode, to generate second YUV data of the first image; and converting the second YUV data into the transparency data of the first image.

In an embodiment, when converting the second YUV data into the transparency data of the first image, the processor 2001 specifically performs the following operation:

setting a Y component in the second YUV data as the transparency data of the first image, and discarding a U component and a V component in the second YUV data.

In an embodiment, the processor 2001 further performs the following steps:

determining, if the image file is an image file in a dynamic format and the first image is an image corresponding to a k^{th} frame in the image file in the dynamic format, whether the k^{th} frame is the last frame in the image file, where k is a positive integer greater than 0; and obtaining, if the k^{th} frame is not the last frame in the image file, from the stream data segment of the image file, third stream data and fourth stream data that are generated from a second image corresponding to a (k+1)^{th} frame in the image file;

decoding the third stream data according to a third video decoding mode, to generate RGB data of the second image;

decoding the fourth stream data according to a fourth video decoding mode, to generate transparency data of the second image; and

generating, according to the RGB data and the transparency data of the second image, RGBA data corresponding to the second image.

In an embodiment, before decoding the first stream data according to the first video decoding mode, to generate the RGB data of the first image, the processor 2001 further performs the following step:

parsing the image file, to obtain image header information and frame header information of the image file, where the image header information includes image feature information indicating whether there is transparency data in the image file, and the frame header information is used to indicate the stream data segment of the image file.

In an embodiment, when parsing the image file, to obtain the image header information of the image file, the processor 2001 specifically performs the following operation:

reading the image header information of the image file from an image header information data segment of the image file.

In an embodiment, when parsing the image file, to obtain the frame header information of the image file, the processor 2001 specifically performs the following operation:

reading the frame header information of the image file from a frame header information data segment of the image file.

In an embodiment, the processor 2001 further performs the following step:

reading, if it is determined, by using the image feature information, that the image file includes transparency data, stream data from a stream data segment indicated by the frame header information of the image file, where the stream data includes first stream data and second stream data.

It should be noted that, steps performed by and a beneficial effect brought by the processor 2001 described in this embodiment of this application may be specifically implemented according to the methods in the method embodiments shown in FIG. 9 to FIG. 11. Details are not described herein again.

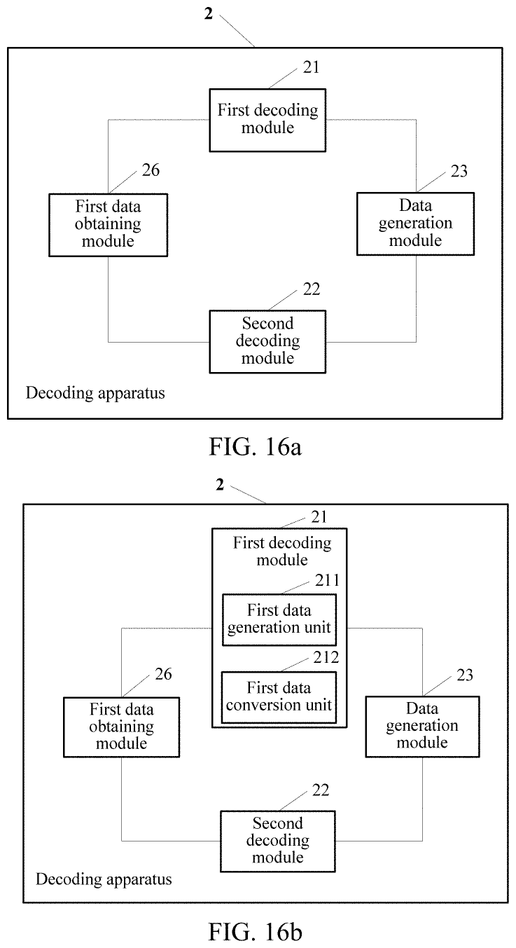

FIG. 18 is a schematic structural diagram of an image file processing apparatus according to an embodiment of this application. As shown in FIG. 18, the image file processing apparatus 3 in this embodiment of this application may include an information generation module 31. In some embodiments of this application, the image file processing apparatus 3 may further include at least one of a first information writing module 32, a second information writing module 33, a data encoding module 34, and a data writing module 35.

The information generation module 31 is configured to generate image header information and frame header information that correspond to an image file, where the image header information includes image feature information indicating whether there is transparency data in the image file, and the frame header information is used to indicate a stream data segment of the image file.

In some embodiments of this application, the image file processing apparatus 3 further includes:

a first information writing module 32, configured to write the image header information into an image header information data segment of the image file.

The image file processing apparatus 3 further includes a second information writing module 33.

The second information writing module 33 is configured to write the frame header information into a frame header information data segment of the image file.

The image file processing apparatus 3 further includes a data encoding module 34 and a data writing module 35.

The data encoding module 34 is configured to: encode, if it is determined, according to the image feature information, that the image file includes the transparency data, RGB data included in RGBA data corresponding to a first image included in the image file, to generate first stream data, and encode the included transparency data, to generate second stream data.

The data writing module 35 is configured to write the first stream data and the second stream data into a stream data segment indicated by frame header information corresponding to the first image.

It should be noted that, modules executed by and a beneficial effect brought by the image file processing apparatus 3 described in this embodiment of this application may be specifically implemented according to the method in the method embodiment shown in FIG. 12. Details are not described herein again.

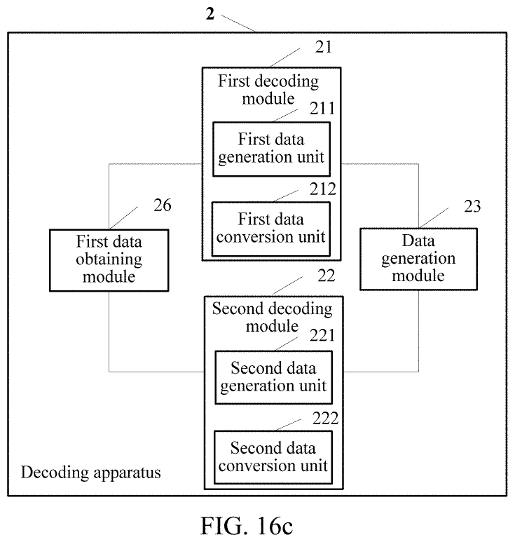

FIG. 19 is a schematic structural diagram of another image file processing apparatus according to an embodiment of this application. As shown in FIG. 19, the image file processing apparatus 3000 may include at least one processor 3001, for example, a CPU, at least one network interface 3004, a memory 3005, and at least one communications bus 3002. The network interface 3004 may include a standard wired interface or wireless interface (for example, a Wi-Fi interface). The memory 3005 may be a high-speed RAM, or may be a non-volatile memory, for example, at least one magnetic disk memory. The memory 3005 may alternatively be at least one storage apparatus away from the processor 3001. The communications bus 3002 is configured to implement connection and communication between the components.

In some embodiments of this application, the image file processing apparatus 3000 includes a user interface 3003. The user interface 3003 may include a display screen (Display) 30031 and a keyboard 30032. As shown in FIG. 19, the memory 3005 as a computer-readable storage medium may include an operating system 30051, a network communications module 30052, a user interface module 30053, and a machine-readable instruction 30054. The machine-readable instruction 30054 includes an image file processing application program 30055.

In the image file processing apparatus 3000 shown in FIG. 19, the processor 3001 may be configured to: invoke the image file processing application program 30055 stored in the memory 3005, and specifically perform the following operation:

generating image header information and frame header information that correspond to an image file, where the image header information includes image feature information indicating whether there is transparency data in the image file, and the frame header information is used to indicate a stream data segment of the image file.

In an embodiment, the processor 3001 further performs the following step:

writing the image header information into an image header information data segment of the image file.

In an embodiment, the processor 3001 further performs the following step:

writing the frame header information into a frame header information data segment of the image file.

In an embodiment, the processor 3001 further performs the following steps:

encoding, if it is determined, according to the image feature information, that the image file includes the transparency data, RGB data included in RGBA data corresponding to a first image included in the image file, to generate first stream data, and encoding the included transparency data, to generate second stream data; and writing the first stream data and the second stream data into a stream data segment indicated by frame header information corresponding to the first image.

It should be noted that, steps performed by and a beneficial effect brought by the processor 3001 described in this embodiment of this application may be specifically implemented according to the method in the method embodiment shown in FIG. 12. Details are not described herein again.

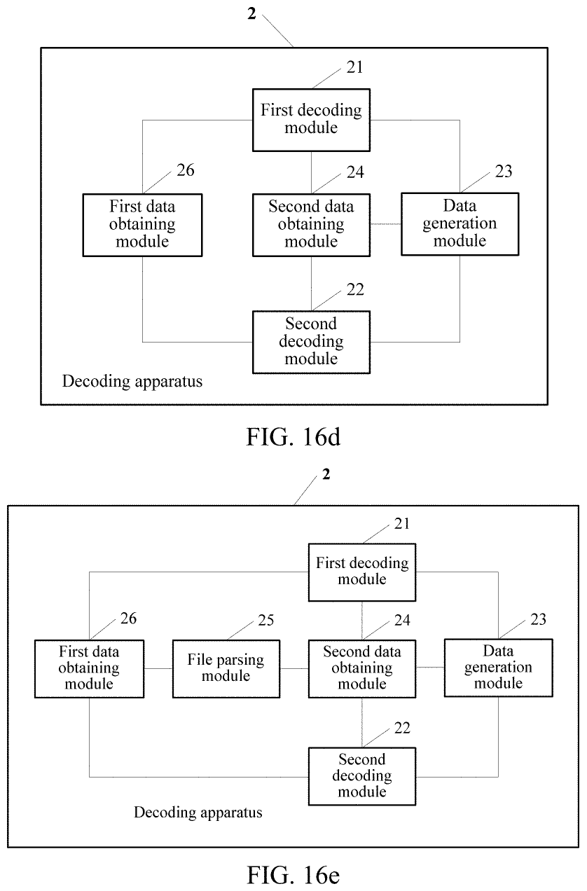

FIG. 20 is a schematic structural diagram of an image file processing apparatus according to an embodiment of this application. As shown in FIG. 20, the image file processing apparatus 4 in this embodiment of this application may include a file parsing module 41. In some embodiments of this application, the image file processing apparatus 4 may further include at least one of a data reading module 42 and a data decoding module 43.

The file parsing module 41 is configured to parse an image file, to obtain image header information and frame header information of the image file, where the image header information includes image feature information indicating whether there is transparency data in the image file, and the frame header information is used to indicate a stream data segment of the image file.

In some embodiments of this application, the file parsing module 41 is specifically configured to read the image header information of the image file from an image header information data segment of the image file.

In some embodiments of this application, the file parsing module 41 is specifically configured to read the frame header information of the image file from a frame header information data segment of the image file.

In some embodiments of this application, the image file processing apparatus 4 further includes a data reading module 42 and a data decoding module 43.

The data reading module 42 is configured to read, if it is determined, by using the image feature information, that the image file includes transparency data, stream data from a stream data segment indicated by the frame header information of the image file, where the stream data includes first stream data and second stream data.

The data decoding module 43 is configured to decode the first stream data and the second stream data respectively.

It should be noted that, modules executed by and a beneficial effect brought by the image file processing apparatus 4 described in this embodiment of this application may be specifically implemented according to the method in the method embodiment shown in FIG. 13. Details are not described herein again.

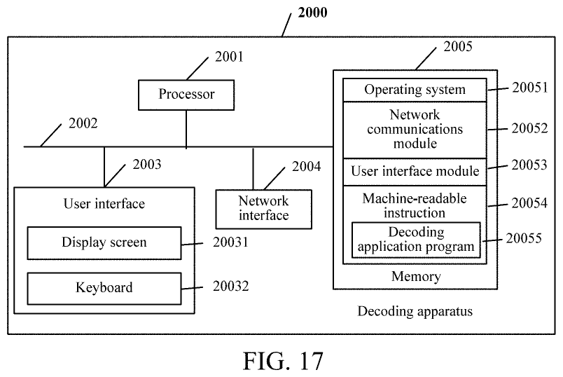

FIG. 21 is a schematic structural diagram of another image file processing apparatus according to an embodiment of this application. As shown in FIG. 21, the image file processing apparatus 4000 may include at least one processor 4001, for example, a CPU, at least one network interface 4004, a memory 4005, and at least one communications bus 4002. The network interface 4004 may include a standard wired interface or wireless interface (for example, a Wi-Fi interface). The memory 4005 may be a high-speed RAM, or may be a non-volatile memory, for example, at least one magnetic disk memory. The memory 4005 may alternatively be at least one storage apparatus away from the processor 4001. The communications bus 4002 is configured to implement connection and communication between the components. In some embodiments of this application, the image file processing apparatus 4000 includes a user interface 4003. The user interface 4003 may include a display screen (Display) 40031 and a keyboard 40032. As shown in FIG. 21, the memory 4005 as a computer-readable storage medium may include an operating system 40051, network communications module 40052, a user interface module 40053, and a machine-readable instruction 40054. The machine-readable instruction 40054 includes an image file processing application program 40055.

In the image file processing apparatus 4000 shown in FIG. 21, the processor 4001 may be configured to: invoke the image file processing application program 40055 stored in the memory 4005, and specifically perform the following operation:

parsing an image file, to obtain image header information and frame header information of the image file, where the image header information includes image feature information indicating whether there is transparency data in the image file, and the frame header information is used to indicate a stream data segment of the image file.

In an embodiment, when parsing the image file, to obtain the image header information of the image file, the processor 4001 specifically performs the following operation:

reading the image header information of the image file from an image header information data segment of the image file.

In an embodiment, when parsing the image file, to obtain the frame header information of the image file, the processor 4001 specifically performs the following operation:

reading the frame header information of the image file from a frame header information data segment of the image file.

In an embodiment, the processor 4001 further performs the following steps:

reading, if it is determined, by using the image feature information, that the image file includes the transparency data, stream data from a stream data segment indicated by the frame header information of the image file, where the stream data includes first stream data and second stream data; and decoding the first stream data and the second stream data respectively.

It should be noted that, steps performed by and a beneficial effect brought by the processor 4001 described in this embodiment of this application may be specifically implemented according to the method in the method embodiment shown in FIG. 13. Details are not described herein again.

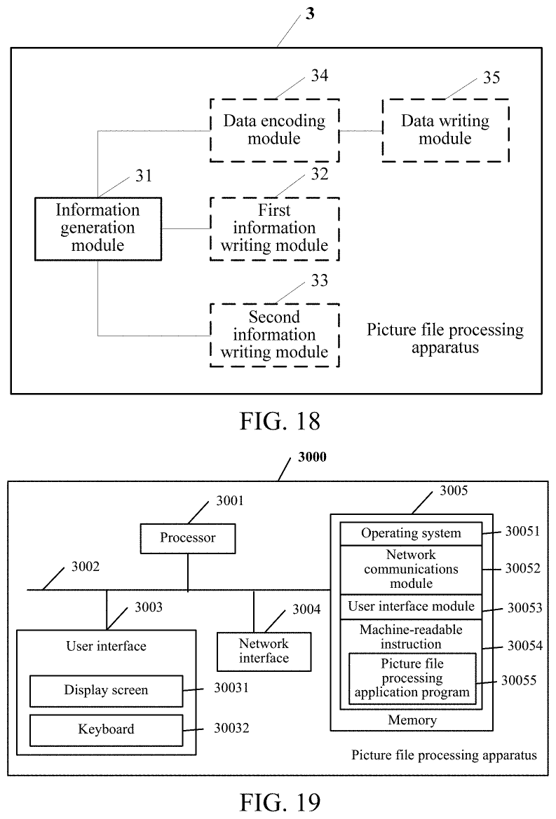

FIG. 22 is a system architecture diagram of an image file processing system according to an embodiment of this application. As shown in FIG. 22, the image file processing system 5000 includes an encoding device 5001 and a decoding device 5002.

In some embodiments of this application, the encoding device 5001 may be the encoding apparatus shown in FIG. 1c to FIG. 8, or may include a terminal device having an encoding module implementing a function of the encoding apparatus shown in FIG. 1c to FIG. 8; and correspondingly, the decoding device 5002 may be the decoding apparatus shown in FIG. 9 to FIG. 11, or may include a terminal device having a decoding module implementing a function of the decoding apparatus shown in FIG. 9 to FIG. 11.

In some other embodiments of this application, the encoding device 5001 may be the image file processing apparatus shown in FIG. 12, or may include an image file processing module implementing a function of the image file processing apparatus shown in FIG. 12; and correspondingly, the decoding device 5002 may be the image file processing apparatus shown in FIG. 13, or may include an image file processing module implementing a function of the image file processing apparatus shown in FIG. 13.

The encoding apparatus, the decoding apparatus, the image file processing apparatus, and the terminal device in the embodiments of this application may include devices such as a tablet computer, a mobile phone, an electronic reader, a PC, a notebook computer, an in-vehicle device, a network television, and a wearable device. This is not limited in the embodiments of this application.

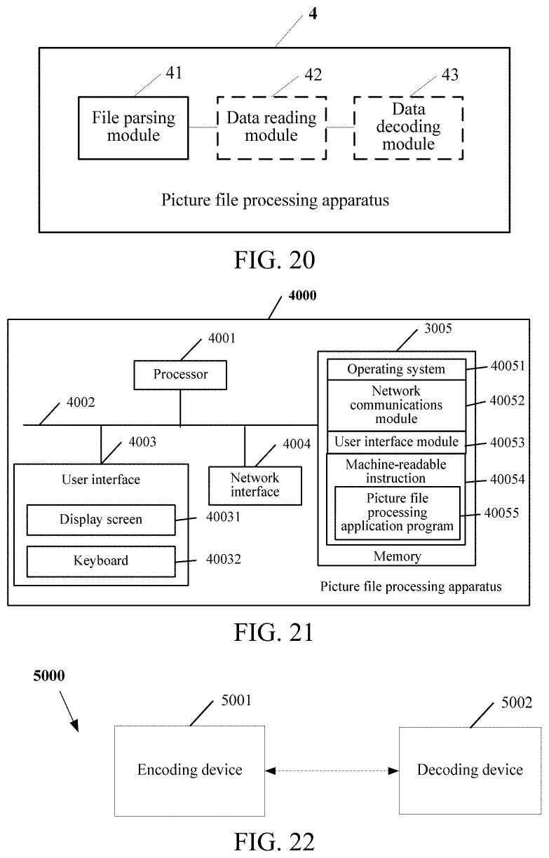

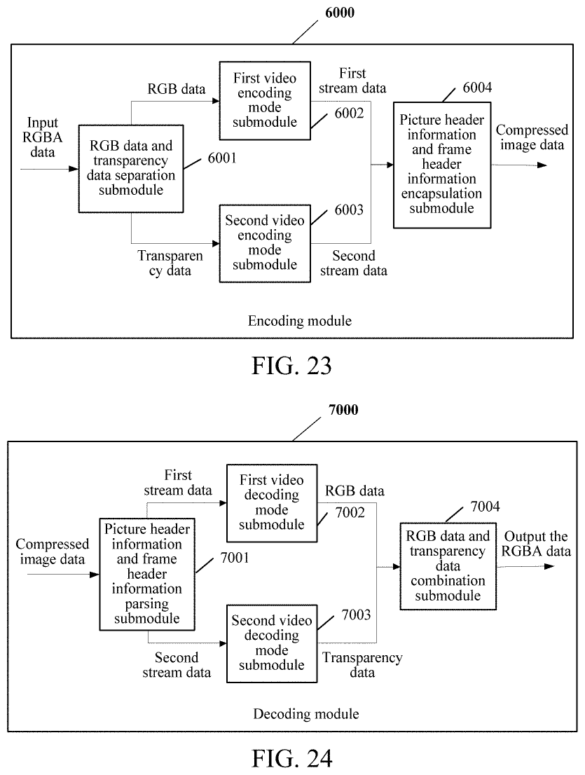

Further, the encoding device 5001 and the decoding device 5002 in the embodiments of this application are described in detail with reference to FIG. 23 and FIG. 24. From the perspective of functional logic, FIG. 23 and FIG. 24 more completely present other aspects that may be involved in the methods shown above, to help a reader further understand the technical solutions recorded in this application. Also refer to FIG. 23 that is an example diagram of an encoding module according to an embodiment of this application. The encoding device 5001 may include an encoding module 6000 shown in FIG. 23, and the encoding module 6000 may include an RGB data and transparency data separation submodule 6001, a first video encoding mode submodule 6002, a second video encoding mode submodule 6003, and an image header information and frame header information encapsulation submodule 6004. The RGB data and transparency data separation submodule 6001 is configured to separate RGBA data in a picture source format into RGB data and transparency data. The first video encoding mode submodule 6002 is configured to encode the RGB data, to generate first stream data. The second video encoding mode submodule 6003 is configured to encode the transparency data, to generate second stream data. The image header information and frame header information encapsulation submodule 6004 is configured to generate image header information and frame header information of stream data including the first stream data and the second stream data, to output compressed image data.

During specific implementation, for an image file in a static format, first, the encoding module 6000 receives input RGBA data of the image file, and divides the RGBA data into RGB data and transparency data by using the RGB data and transparency data separation submodule 6001; then the first video encoding mode submodule 6002 encodes the RGB data according to a first video encoding mode, to generate first stream data; next, the second video encoding mode submodule 6003 encodes the transparency data according to a second video encoding mode, to generate second stream data; and subsequently, the image header information and frame header information encapsulation submodule 6004 generates image header information and frame header information of the image file, writes the first stream data, the second stream data, the frame header information, and the image header information into corresponding data segments, and then generates compressed image data corresponding to the RGBA data.

For an image file in a dynamic format, first, the encoding module 6000 determines a quantity of included frames, and then divides each frame of RGBA data into RGB data and transparency data by using the RGB data and transparency data separation submodule 6001; the first video encoding mode submodule 6002 encodes the RGB data according to a first video encoding mode, to generate first stream data; the second video encoding mode submodule 6003 encodes the transparency data according to a second video encoding mode, to generate second stream data; the image header information and frame header information encapsulation submodule 6004 generates frame header information corresponding to each frame, and writes each piece of stream data and frame header information into corresponding data segments; and finally, the image header information and frame header information encapsulation submodule 6004 generates image header information of the image file, writes the image header information into a corresponding data segment, and then generates compressed image data corresponding to the RGBA data.

In some embodiments of this application, the compressed image data may alternatively be described by using a name such as a compressed stream or an image sequence. This is not limited in this embodiment of this application.

Also refer to FIG. 24 that is an example diagram of a decoding module according to an embodiment of this application. The decoding device 5002 may include a decoding module 7000 shown in FIG. 24. The decoding module 7000 may include an image header information and frame header information parsing submodule 7001, a first video decoding mode submodule 7002, a second video decoding mode submodule 7003, and an RGB data and transparency data combination submodule 7004. The image header information and frame header information parsing submodule 7001 is configured to parse compressed image data of an image file, to determine image header information and frame header information. The compressed image data is data obtained after the encoding module shown in FIG. 23 completes encoding. The first video decoding mode submodule 7002 is configured to decode first stream data, the first stream data being generated from the RGB data. The second video decoding mode submodule 7003 is configured to decode second stream data, where the second stream data is generated from the transparency data. The RGB data and transparency data combination submodule 7004 is configured to combine the RGB data and the transparency data into RGBA data, to output the RGBA data.

During specific implementation, for an image file in a static format, first, the decoding module 7000 parses compressed image data of the image file by using the image header information and frame header information parsing submodule 7001, to obtain image header information and frame header information of the image file, and obtains, if determining, according to the image header information, that there is transparency data in the image file, first stream data and second stream data from a stream data segment indicated by the frame header information; then, the first video decoding mode submodule 7002 decodes the first stream data according to a first video decoding mode, to generate RGB data; next, the second video decoding mode submodule 7003 decodes second stream data according to a second video decoding mode, to generate transparency data; and finally, the RGB data and transparency data combination submodule 7004 combines the RGB data and the transparency data, to generate RGBA data, and outputs the RGBA data.

For an image file in a dynamic format, first, the decoding module 7000 parses compressed image data of the image file by using the image header information and frame header information parsing submodule 7001, to obtain image header information and frame header information of the image file, and determines a quantity of frames included in the image file; and then, obtains, if determining, according to the image header information, that there is transparency data in the image file, first stream data and second stream data from a stream data segment indicated by frame header information of each frame of image; the first video decoding mode submodule 7002 decodes, according to a first video decoding mode, first stream data corresponding to each frame of image, to generate RGB data; the second video decoding mode submodule 7003 decodes, according to a second video decoding mode, second stream data corresponding to each frame of image, to generate transparency data; and finally, the RGB data and transparency data combination submodule 7004 combines the RGB data and the transparency data of each frame of image, to generate RGBA data, and outputs RGBA data of all frames included in the compressed image data.

For the image file processing system shown in FIG. 22, for example, the encoding device 5001 may encode an image file in a source format according to the encoding module shown in FIG. 23, generate compressed image data, and transmit the encoded compressed image data to the decoding device 5002. The decoding device 5002 receives the compressed image data, and then decodes the compressed image data according to the decoding module shown in FIG. 24, to obtain RGBA data corresponding to the image file. The image file in the source format may include, but is not limited to, jpeg, png, gif, or the like.

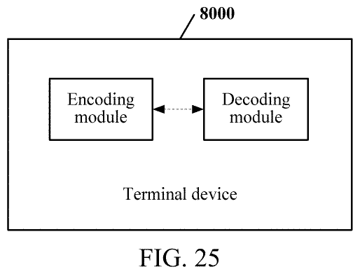

FIG. 25 is a schematic structural diagram of a terminal device according to an embodiment of this application. As shown in FIG. 25, the terminal device 8000 includes an encoding module and a decoding module. In some embodiments of this application, the encoding module may be an encoding module for implementing a function of the encoding apparatus shown in FIG. 1c to FIG. 8c. Correspondingly, the decoding module may be a decoding module implementing a function of the decoding apparatus shown in FIG. 9 to FIG. 11. In some embodiments of this application, the encoding module may implement encoding according to the encoding module 6000 in FIG. 23, and the decoding module may implement decoding according to the decoding module 7000 shown in FIG. 24. For a specific implementation process, refer to detailed descriptions of a corresponding embodiment. Details are not described herein again. In this way, a terminal device can encode an image file in a source format such as jpeg, png, or gif, to form an image file in a new format. In this way, through encoding by using video encoding modes, a compression ratio of the image file can be improved, and a size of the image file can be reduced, so that a picture loading speed can be increased, and network transmission bandwidth and storage costs can be reduced. In addition, RGB data and transparency data in the image file are encoded respectively, to use video encoding modes and reserve the transparency data in the image file, thereby ensuring quality of the image file. The terminal device can further decode the image file in the new format, to obtain corresponding RGBA data, to obtain the RGB data and the transparency data through decoding by using a video decoding mode, thereby ensuring quality of the image file.

A person of ordinary skill in the art may understand that all or some of the processes of the methods in the embodiments may be implemented by a computer program instructing relevant hardware. The program may be stored in a computer-readable storage medium. When the program is run by a processor, the processes of the methods in the embodiments are performed. The foregoing storage medium may be a magnetic disc, an optical disc, a read-only memory (ROM), a RAM, or the like.

The foregoing disclosure is merely exemplary embodiments of this application, and certainly is not intended to limit the protection scope of this application. Therefore, equivalent variations made in accordance with the claims of this application shall fall within the scope of this application.

What is claimed is:

1. An image file processing method performed at a computing device having one or more processors and memory storing a plurality of programs to be executed by the one or more processors, the method comprising:
obtaining RGBA data corresponding to a first image in an image file;
separating the RGBA data to obtain RGB data and transparency data of the first image, the RGB data being color data comprised in the RGBA data, and the transparency data being transparency data comprised in the RGBA data;
encoding the RGB data of the first image, to generate first stream data;
encoding the transparency data of the first image, to generate second stream data; and
combining the first stream data and the second stream data into a stream data segment of the image file;
wherein at least image header information corresponding to the image file comprises image feature information indication of transparency data in the image file.

2. The method according to claim 1, wherein the encoding the RGB data of the first image, to generate first stream data comprises:
converting the RGB data of the first image into first YUV data; and
encoding the first YUV data according to a first video encoding mode, to generate the first stream data.

3. The method according to claim 1, wherein the encoding the transparency data of the first image, to generate second stream data comprises:
converting the transparency data of the first image into second YUV data; and
encoding the second YUV data according to a second video encoding mode, to generate the second stream data.

4. The method according to claim 1, further comprising:
determining, if the image file is an image file in a dynamic format and the first image is an image corresponding to a kth frame in the image file, whether the kth frame is the last frame in the image file, wherein k is a positive integer greater than 0;
obtaining, if the kth frame is not the last frame in the image file, RGBA data corresponding to a second image corresponding to a (k+1)th frame in the image file, and separating the RGBA data corresponding to the second image to obtain RGB data and transparency data of the second image;
encoding the RGB data of the second image, to generate third stream data;
encoding the transparency data of the second image, to generate fourth stream data; and
combining the third stream data and the fourth stream data into a stream data segment of the image file.

5. The method according to claim 1, further comprising:
generating the image header information and frame header information that correspond to the image file, wherein the frame header information is used to indicate the stream data segment of the image file.

6. The method according to claim 5, further comprising:
writing the image header information into an image header information data segment of the image file, wherein
the image header information comprises an image file identifier, a decoder identifier, a version number, and the image feature information; the image file identifier is used to indicate a type of the image file; the decoder identifier is used to indicate an identifier of an encoding/decoding standard used for the image file; and the version number is used to indicate a profile of the encoding/decoding standard used for the image file.

7. The method according to claim 5, further comprising:
writing the frame header information into a frame header information data segment of the image file, wherein the frame header information comprises a frame header information start code and delay time information used for indication if the image file is the image file in the dynamic format.

8. The method according to claim 1, further comprising:
before obtaining RGBA data corresponding to a first image in an image file:
generating image header information and frame header information that correspond to the image file, wherein the image header information comprises image feature information indicating whether there is transparency data in the image file, and the frame header information is used to indicate the stream data segment of the image file;
writing the image header information into an image header information data segment of the image file;
writing the frame header information into a frame header information data segment of the image file; and
in accordance with a determination, based on the image feature information, that the image file comprises transparency data, performing the step of obtaining RGBA data corresponding to a first image in an image file, and separating the RGBA data to obtain RGB data and transparency data of the first image.

9. The method according to claim 8, wherein the combining the first stream data and the second stream data into a stream data segment of the image file comprises:
combining the first stream data and the second stream data into a stream data segment indicated by frame header information corresponding to the first image.

10. A computing device having one or more processors, memory coupled to the one or more processors, and a plurality of programs stored in the memory, wherein the plurality of programs, when executed by the one or more processors, cause the computing device to perform a plurality of operations comprising:
obtaining RGBA data corresponding to a first image in an image file;
separating the RGBA data to obtain RGB data and transparency data of the first image, the RGB data being color data comprised in the RGBA data, and the transparency data being transparency data comprised in the RGBA data;
encoding the RGB data of the first image, to generate first stream data;
encoding the transparency data of the first image, to generate second stream data; and
combining the first stream data and the second stream data into a stream data segment of the image file;
wherein at least image header information corresponding to the image file comprises image feature information indication of transparency data in the image file.

11. The computing device according to claim 10, wherein the operation of encoding the RGB data of the first image, to generate first stream data comprises:
converting the RGB data of the first image into first YUV data; and
encoding the first YUV data according to a first video encoding mode, to generate the first stream data.

12. The computing device according to claim 10, wherein the operation of encoding the transparency data of the first image, to generate second stream data comprises:
converting the transparency data of the first image into second YUV data; and
encoding the second YUV data according to a second video encoding mode, to generate the second stream data.

13. The computing device according to claim 10, wherein the plurality of operations further comprise:
determining, if the image file is an image file in a dynamic format and the first image is an image corresponding to a kth frame in the image file, whether the kth frame is the last frame in the image file, wherein k is a positive integer greater than 0;
obtaining, if the kth frame is not the last frame in the image file, RGBA data corresponding to a second image corresponding to a (k+1)th frame in the image file, and separating the RGBA data corresponding to the second image to obtain RGB data and transparency data of the second image;
encoding the RGB data of the second image, to generate third stream data;
encoding the transparency data of the second image, to generate fourth stream data; and
combining the third stream data and the fourth stream data into a stream data segment of the image file.

14. The computing device according to claim 10, wherein the plurality of operations further comprise:
generating the image header information and frame header information that correspond to the image file, wherein the frame header information is used to indicate the stream data segment of the image file.

15. The computing device according to claim 14, wherein the plurality of operations further comprise:
writing the image header information into an image header information data segment of the image file, wherein
the image header information comprises an image file identifier, a decoder identifier, a version number, and the image feature information; the image file identifier is used to indicate a type of the image file; the decoder identifier is used to indicate an identifier of an encoding/decoding standard used for the image file; and the version number is used to indicate a profile of the encoding/decoding standard used for the image file.

16. The computing device according to claim 15, wherein the image feature information further comprises an image feature information start code, an image feature information data segment length, information about whether the picture file is a picture file in a static format, whether the picture file is the picture file in the dynamic format, and whether the picture file is losslessly encoded, a YUV color space value domain used for the picture file, a width of the picture file, a height of the picture file, and a frame quantity used for indication if the picture file is the picture file in the dynamic format.

17. The computing device according to claim 14, wherein the plurality of operations further comprise:
writing the frame header information into a frame header information data segment of the image file, wherein
the frame header information comprises a frame header information start code and delay time information used for indication if the image file is the image file in the dynamic format.

18. The computing device according to claim 10, wherein the plurality of operations further comprise:
before obtaining RGBA data corresponding to a first image in an image file:
generating image header information and frame header information that correspond to the image file, wherein the image header information comprises image feature information indicating whether there is transparency data in the image file, and the frame header information is used to indicate the stream data segment of the image file;
writing the image header information into an image header information data segment of the image file;
writing the frame header information into a frame header information data segment of the image file; and
in accordance with a determination, based on the image feature information, that the image file comprises transparency data, performing the step of obtaining RGBA data corresponding to a first image in an image file, and separating the RGBA data to obtain RGB data and transparency data of the first image.

19. The method according to claim 8, wherein the combining the first stream data and the second stream data into a stream data segment of the image file comprises:
combining the first stream data and the second stream data into a stream data segment indicated by frame header information corresponding to the first image.

20. A non-transitory computer readable storage medium storing a plurality of machine readable instructions in connection with a computing device having one or more processors, wherein the plurality of machine readable instructions, when executed by the one or more processors, cause the computing device to perform a plurality of operations including:
obtaining RGBA data corresponding to a first image in an image file;
separating the RGBA data to obtain RGB data and transparency data of the first image, the RGB data being color data comprised in the RGBA data, and the transparency data being transparency data comprised in the RGBA data;
encoding the RGB data of the first image, to generate first stream data;
encoding the transparency data of the first image, to generate second stream data; and
combining the first stream data and the second stream data into a stream data segment of the image file;
wherein at least image header information corresponding to the image file comprises image feature information indication of transparency data in the image file.
